(19) United States
(12) Patent Application Publication
(10) Pub. No.: US 2026/0137081 A1
(43) Pub. Date: May 21, 2026

(54) SUBSTITUTED FURANONES AND USE THEREOF FOR AGRICULTURAL APPLICATIONS

(71) Applicant: SOUND AGRICULTURE COMPANY, EMERYVILLE, CA (US)

(72) Inventors: Travis BAYER, Bend, OR (US); Christian IBARRA, Half Moon Bay, CA (US); Cynthia AMSTUTZ, Berkeley, CA (US); Nina Rosa CASTILLO, Woodland, CA (US); Tamara MERAGELMAN DE PEDROSA, Davis, CA (US)

(21) Appl. No.: 18/705,954

(22) PCT Filed: Oct. 27, 2022
(86) PCT No.: PCT/US2022/048054

§ 371 Date: Apr. 29, 2024

Related U.S. Application Data
(60) Provisional application No. 63/272,596, filed on Oct. 27, 2021.

(51) Int. Cl. A01N 43/16; A01N 43/28; A01P 21/00

(52) U.S. Cl. CPC A01N 43/16; A01N 43/28; A01P 21/00

(57) ABSTRACT

Methods and agricultural formulations for the cultivation of plants such as broad acre crops, fruits and vegetables, perennial tree crops, and ornamentals are described. The methods include contacting the plant with a furanone compound according to Formula I, II, III, IV, V, VI, VII, VIII, IX, X, XI, XII, XIII, or XIV as described herein, or a salt or solvate thereof. The methods can provide cultivated plants exhibiting reduced levels of non-photochemical quenching (NPQ), higher levels of carbon fixation, higher levels of carbon storage, increased quantum efficiency, and/or increased stomatal conductance, leading to increased biomass and/or increased crop yields. Furanone compounds and agricultural formulations containing the compounds are also described.

### CROSS-REFERENCE TO RELATED APPLICATION

This application is a PCT application claiming the benefit of and priority to U.S. Provisional Application No. 63/272,596, filed Oct. 27, 2021, the entire contents of which are incorporated herein for all purposes.

### BACKGROUND

During photosynthesis most absorbed photons are utilized efficiently to drive electrons in the electron-transport chain at low sunlight intensities. However, under bright sunlight conditions, plants utilize photons inefficiently, with only about 20% of the incoming sunlight energy being used in photosynthesis, while the rest of the sunlight energy is dissipated via a process known as non-photochemical quenching (NPQ). During NPQ, the plant quenches singlet-excited chlorophylls (Chl) and dissipates excess excitation energy as heat through molecular vibrations. Thus, there is a need in the art to increase the amount of light energy that is used by plants.

### SUMMARY

Provided herein are methods for cultivating plants such as broad acre crops, fruits and vegetables, perennial tree crops, and ornamentals. The methods include contacting the plant with an effective amount of a furanone compound according to Formula I:

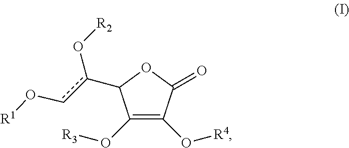

or a salt or solvate thereof, wherein:
[symbol] is either a single or double bond;
R¹ and R² are independently selected from the group consisting of H, C₁₋₆ alkyl, C₁₋₆ alkyl-diol, 2- to 6-membered heteroalkyl, C₃₋₈ cycloalkyl, C₆₋₁₀ aryl, (C₆₋₁₀ aryl)-C₆₋₁₀ alkyl, 5- to 12-membered heteroaryl, (5- to 12-membered heteroaryl)-C₆₋₁₀ alkyl, 5- to 12-membered heterocyclyl, —C(O)R⁵, —C(O)₂R⁵, —C(O)N(R⁵)₂, —S(O)R⁵, and —S(O)₂R⁵;
R¹ and R² are optionally taken together with the oxygen atoms to which they are attached to form a ring which is optionally substituted with one or more R⁶ groups or R⁷ groups;
R³ and R⁴ are independently selected from the group consisting of phosphate, hydrogen phosphate, monohydrogen phosphate, and dihydrogen phosphate, H, C₁₋₆ alkyl, C₁₋₆ alkyl-diol, 2- to 6-membered heteroalkyl, C₃₋₈ cycloalkyl, C₆₋₁₀ aryl, (C₆₋₁₀ aryl)-C₆₋₁₀ alkyl, 5- to 12-membered heteroaryl, (5- to 12-membered heteroaryl)-C₆₋₁₀ alkyl, 5- to 12-membered heterocyclyl, —C(O)R⁵, —C(O)₂R⁵, —C(O)N(R⁵)₂, —S(O)R⁵, and —S(O)₂R⁵;
each R⁵ is independently selected from the group consisting of H, C₁₋₆ alkyl, 2- to 6-membered heteroalkyl, C₃₋₈ cycloalkyl, C₆₋₁₀ aryl, hydroxy-(C₆₋₁₀ aryl), (C₆₋₁₀ aryl)-C₆₋₁₀ alkyl, 5- to 12-membered heteroaryl, (5- to 12-membered heteroaryl)-C₆₋₁₀ alkyl, 5- to 12-membered heterocyclyl, and 5- to 12-membered substituted heterocyclyl; and
each R⁶ and R⁷ is independently selected from the group consisting of H, halo, amino, hydroxy, —OR⁵, —N(R⁵)₂, C₁₋₆ alkyl, 2- to 6-membered heteroalkyl, C₃₋₈ cycloalkyl, C₆₋₁₀ aryl, (C₆₋₁₀ aryl)-C₆₋₁₀ alkyl, 5- to 12-membered heteroaryl, (5- to 12-membered heteroaryl)-C₆₋₁₀ alkyl, and 5- to 12-membered heterocyclyl.

Contacting the plant with the compound according to Formula I may include contacting the plant with an agricultural formulation comprising the compound of Formula I, or a salt or solvate thereof, and an agriculturally acceptable carrier.

In some embodiments, contacting the plant with the compound according to Formula I increases the biomass of the plant or the yield of the plant, relative to the biomass of a comparable plant grown for a comparable amount of time and not contacted with the compound.

In some embodiments, plants cultivated according to the methods provided herein exhibit reduced levels of non-photochemical quenching (NPQ), higher levels of carbon fixation, higher levels of carbon storage, increased quantum efficiency, and/or increased stomatal conductance as compared to plants that are not treated with furanone compounds.

Also provided herein are furanone compounds and agricultural formulations containing the furanone compounds.

The preceding Summary is provided to introduce a selection of concepts that are further described below in the Detailed Description. This Summary is not intended to identify key or essential features of the claimed subject matter, nor is it intended to be used as an aid in limiting the scope of the claimed subject matter

### BRIEF DESCRIPTION OF THE DRAWINGS

FIG. 1 shows the average yield (bushel/acre) in corn plants treated with varying amounts (0.8 fl. oz, 1.7 fl. oz, or 3.4 fl. oz) of a liquid formulation containing Compound 1 via foliar application, as compared to a mock treatment. The total amount of Compound 1 applied to each plot ranged from about 5 g/acre to about 20 g/acre.

FIG. 2 shows a representative photo of foliar application of Compound 1 to plants. Plants were sprayed with a mock formulation or formulated Compound 1 (0.8 fl. oz or 1.7 fl. oz) until leaves were evenly and consistently coated, and then allowed to dry.

FIG. 3A shows net CO₂ assimilation (Anet) in corn leaves treated with a Compound 1 formulation (0.8 fl. oz or 1.7 fl. oz) or a mock formulation. The mean of each treatment is shown as a number below each box plot. The total amount of Compound 1 applied ranged from about 5 g/acre to about 10 g/acre.

FIG. 3B shows transpiration (E) in corn leaves treated with a Compound 1 formulation (0.8 fl. oz or 1.7 fl. oz) or a mock formulation. The mean of each treatment is shown as a number below each box plot. The total amount of Compound 1 applied ranged from about 5 g/acre to about 10 g/acre.

FIG. 3C shows stomatal conductance (gsw) in corn leaves treated with a Compound 1 formulation (0.8 fl. oz or 1.7 fl. oz) or a mock formulation. The mean of each treatment is shown as a number below each box plot. The total amount of Compound 1 applied ranged from about 5 g/acre to about 10 g/acre.

FIG. 4 shows an assessment of carbon fixation vs. light intensity in tobacco plants treated with Compound 1.

FIG. 5 shows an assessment of carbon fixation vs. light intensity in soy plants treated with Compound 1.

FIG. 6 shows minimal fluorescence (Fₒ; left panel), maximum fluorescence (Fₘ; middle panel) and quantum efficiency of PSII (Fᵥ/Fₘ; right panel) determined 4 h and 24 h after foliar application of formulated Compound 1 (0.8 fl. oz or 1.7 fl. oz) or a mock formulation to dark-adapted corn plants.

FIG. 7 shows minimal fluorescence (Fₒ′), maximum fluorescence (Fₘ′) and quantum efficiency of PSII (Fᵥ′/Fₘ′) determined 4 h and 24 h after foliar application of formulated Compound 1 (0.8 fl. oz or 1.7 fl. oz) or a mock formulation to light-adapted corn plants.

FIG. 8 shows mean photosynthetic assimilation (μmol m⁻² s⁻¹) of water, formulated Compound 1 DC (DC) and formulated Compound 1 OD (OD) treatments.

FIG. 9 shows mean digital biomass (mm³) of water, formulated Compound 1 DC and formulated Compound 1 OD treatments.

FIG. 10 shows mean shoot dry weights (g) of water, formulated Compound 1 DC, formulated Compound 1 OD treatments.

FIG. 11 shows mean photosynthetic assimilation (μmol m⁻² s⁻¹) of formulation blank (FB) DC and formulated Compound 1 DC treatments.

FIG. 12 shows mean digital biomass (mm³) of formulation blank (FB) DC and formulated Compound 1 DC treatments.

FIG. 13 shows mean normalized difference vegetation index (NDVI) for formulation blank (FB) DC and formulated Compound 1 DC treatments.

FIG. 14 shows mean shoot dry weight of formulation blank (FB) DC and formulated Compound 1 DC Treatments.

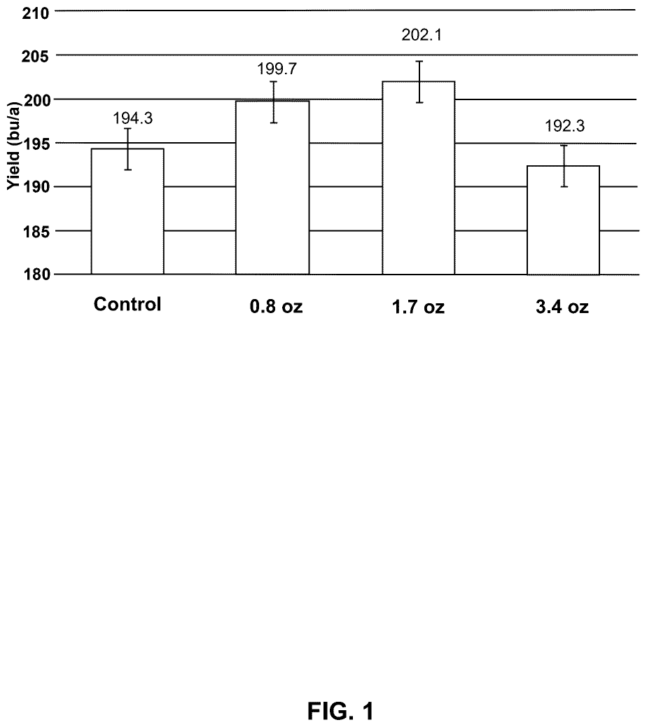

### DETAILED DESCRIPTION

The present invention is based, in part, on the discovery that furanone derivatives can be used for increasing carbon fixation and carbon storage in plants, resulting in plants with higher yield and biomass. Plants protect themselves from excess light energy by non-photochemical quenching (NPQ), i.e., the quenching of singlet-excited chlorophylls (Chl) and dissipation of excess excitation energy as heat through molecular vibrations. As described herein, it has now been discovered that substituted furanone compounds can modulate the NPQ pathway such that the plant can continue light harvesting and photosynthesis, leading to higher levels of carbon fixation and ultimately an increase in biomass.

### I. Terminology

The following definitions are provided to assist the reader. Unless otherwise defined, all terms of art, notations, and other scientific or medical terms or terminology used herein are intended to have the meanings commonly understood by those of skill in the chemical and medical arts. In some cases, terms with commonly understood meanings are defined herein for clarity and/or for ready reference, and the inclusion of such definitions herein should not be construed as representing a substantial difference over the definition of the term as generally understood in the art.

Articles “a” and “an” are used herein to refer to one or to more than one (i.e., at least one) of the grammatical object of the article. By way of example, “an element” means at least one element and can include more than one element.

The use herein of the terms “including,” “comprising,” or “having,” and variations thereof, is meant to encompass the elements listed thereafter and equivalents thereof as well as additional elements. Embodiments recited as “including,” “comprising,” or “having” certain elements are also contemplated as “consisting essentially of” and “consisting of those certain elements.” As used herein, “and/or” refers to and encompasses any and all possible combinations of one or more of the associated listed items, as well as the lack of combinations where interpreted in the alternative (“or”).

Recitation of ranges of values herein are merely intended to serve as a shorthand method of referring individually to each separate value falling within the range, unless otherwise-Indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure.

The term “about” when used before a numerical designation, e.g., temperature, time, amount, concentration, and such other, including a range, indicates approximations which may vary by (+) or (−) 10%, 5% or 1%, or any subrange or subvalue there between.

The term “plant” can be used interchangeably with the term “crop” and refers to any crop, cultivated plant, fungus, or alga that may be harvested for food, clothing, livestock fodder, biofuel, medicine, or other uses. For example, plants include field and greenhouse crops, including but not limited to broad acre crops, fruits and vegetables, perennial tree crops, and ornamentals. Plants include, but are not limited to sugarcane, pumpkin, maize (corn), wheat, rice, cassava, soybeans, hay, potatoes, cotton, tomato, alfalfa, and green algae. Plants also include, but are not limited to any vegetable, such as cabbage, turnip, carrot, parsnip, beetroot, lettuce, beans, broad beans, peas, potato, eggplant, tomato, cucumber, pumpkin, squash, onion, garlic, leek, pepper, spinach, yam, sweet potato, and cassava. In some instances, the plant can also include a fruit, a leaf, a stalk, a root, a flower, a plant embryo, a seedling, or any combination thereof.

The term “reference plant” is used herein to refer to substantially comparable plant to which a treatment or formulation as described herein has not been applied. The term “substantially comparable plant” refers to a plant of the same species, variety, or cultivar as the plant to which comparison is being made. The substantially comparable plant typically has been cultivated for a comparable amount of time under comparable conditions to the plant to which comparison is being made.

Unless otherwise indicated, “applied”, “treated”, and “contacted” are used interchangeably. Similarly, “untreated” and “uncontacted” are also used interchangeably.

As used herein, the term “effective amount” refers to an amount of compound, such as a compound of Formula I, II, III, IV, V, VI, VII, VIII, IX, X, XI, XII, XIII, or XIV, that produces the effect in plants for which it is applied. The exact amount will depend on the factors including, not limited to, the type of plant to which the compound is applied and the environmental conditions where the plant is cultivated.

As used herein, the term “cultivation” means to grow plants in any stage from the seeding stage to the maturation stage of the plant growth. Cultivation may refer, for example, to growing plants over the entire period, or any part of the period, from the seeding stage to the maturation stage.

The term “compounds” can refer to compounds encompassed by generic formulae disclosed herein, any subgenus of those generic formulae, and any specific compounds within those generic or subgeneric formulae. The compounds can be a specific species, a subgenus or larger genus identified either by their chemical structure and/or chemical name. Further, compounds also include substitutions or modifications of any of such species, subgenuses or genuses, which are set forth herein. When the chemical structure and chemical name conflict, the chemical structure can be determinative of the identity of the compound. The compounds can contain one or more chiral centers and/or double bonds and therefore, can exist as stereoisomers, isomers, enantiomers or diastereomers. Accordingly, the chemical structures within the scope of the specification encompass all possible enantiomers and stereoisomers of the illustrated compounds including the stereoisomerically pure form (e.g., geometrically pure, enantiomerically pure or diastereomerically pure) and enantiomeric and stereoisomeric mixtures.

Further, when partial structures of the compounds are illustrated, asterisks indicate the point of attachment of the partial structure to the rest of the molecule. Enantiomeric and stereoisomeric mixtures can be resolved into their component enantiomers or stereoisomers using separation techniques or chiral synthesis techniques well known to the skilled artisan. The compounds can include any salt or solvate forms of the compounds. The compounds can include any derivatives of the compounds.

The term “derivative,” which can be used interchangeably with the term “analog.” Compound A can be a derivative or analog of compound B if 1, 2, 3, 4, or 5 atoms of compound A is replaced by another atom or a functional group (e.g., amino, halo, substituted or unsubstituted alkyl, substituted or unsubstituted aryl, substituted or unsubstituted heteroalkyl, substituted or unsubstituted arylalkyl, substituted or unsubstituted heteroaryl, substituted or unsubstituted heteroarylalkyl, substituted or unsubstituted cycloalkyl, or substituted or unsubstituted heterocycloalkyl) to form compound B. The term “derivative” may also refer to a chemical compound that is structurally similar to another but differs slightly in formulation (as in the replacement of one atom by an atom of a different element or in the presence of a particular functional group).

The term “solvate” is used herein to describe a molecular complex comprising a compound (e.g., a compound Formula I, II, III, IV, V, VI, VII, VIII, IX, X, XI, XII, XIII, or XIV, or an agriculturally acceptable salt thereof), and one or more agriculturally acceptable solvent molecules. Examples of solvates include, but are not limited to, isopropanol solvates, ethanol solvates, methanol solvates, DMSO solvates, ethyl acetate solvates, acetic acid solvates, ethanolamine solvates, and combinations thereof. The term “hydrate” may be employed when said solvent is water. Solvates can include, but are not limited to, those that retain one or more of the activities and/or properties of the parent compound(s) and that are not undesirable.

The term “salt” can include, but are not limited to, salts that retain one or more of the activities and properties of the free acids and bases and that are not undesirable. Illustrative examples of salts include, but are not limited to, sulfates, pyrosulfates, bisulfates, sulfites, bisulfites, phosphates, monohydrogenphosphates, dihydrogenphosphates, metaphosphates, pyrophosphates, chlorides, bromides, iodides, acetates, propionates, decanoates, caprylates, acrylates, formates, isobutyrates, caproates, heptanoates, propiolates, oxalates, malonates, succinates, suberates, sebacates, fumarates, maleates, butyne-1,4-dioates, hexyne-1,6-dioates, benzoates, chlorobenzoates, methylbenzoates, dinitrobenzoates, hydroxybenzoates, methoxybenzoates, phthalates, sulfonates, xylenesulfonates, phenylacetates, phenylpropionates, phenylbutyrates, citrates, lactates, γ-hydroxybutyrates, glycolates, tartrates, methanesulfonates, propanesulfonates, naphthalene-1-sulfonates, naphthalene-2-sulfonates, and mandelates.

The term “agriculturally acceptable carrier” as used herein refers to a carrier that is not unacceptably damaging to a plant or its environment, and/or not unsafe to the user or others that may be exposed to the material when used as described herein. For example, an agriculturally acceptable carrier may be a solid carrier, a gel carrier, a liquid carrier, a suspension, or an emulsion. Agriculturally acceptable carriers may include, for example, adjuvants, inert components, dispersants, surfactants, tackifiers, binders, and/or stabilizers.

As used herein, the term “alkyl,” by itself or as part of another substituent, refers to a straight or branched, saturated, aliphatic radical having the number of carbon atoms indicated. Alkyl can include any number of carbons, such as C₁₋₂, C₁₋₃, C₁₋₄, C₁₋₅, C₁₋₆, C₁₋₇, C₁₋₅, C₁₋₉, C₁₋₁₀, C₂₋₃, C₂₋₄, C₂₋₅, C₂₋₆, C₃₋₄, C₃₋₅, C₃₋₆, C₄₋₅, C₄₋₆ and C₅₋₆. For example, C₁₋₆ alkyl includes, but is not limited to, methyl, ethyl, propyl, isopropyl, butyl, isobutyl, sec-butyl, tert-butyl, pentyl, isopentyl, hexyl, etc. Alkyl can also refer to alkyl groups having up to 20 carbons atoms, such as, but not limited to heptyl, octyl, nonyl, decyl, etc. Alkyl groups can be substituted or unsubstituted. Unless otherwise specified, “substituted alkyl” groups can be substituted with one or more groups selected from halo, hydroxy, amino, alkylamino, amido, acyl, nitro, cyano, and alkoxy.

As used herein, the term “alkoxy,” by itself or as part of another substituent, refers to a group having the formula —OR, wherein R is alkyl.

As used herein, the term “cycloalkyl,” by itself or as part of another substituent, refers to a saturated or partially unsaturated, monocyclic, fused bicyclic or bridged polycyclic ring assembly containing from 3 to 12 ring atoms, or the number of atoms indicated. Cycloalkyl can include any number of carbons, such as C₃₋₆, C₄₋₆, C₅₋₆, C₃₋₈, C₄₋₈, C₅₋₈, C₆₋₈, C₃₋₉, C₃₋₁₀, C₃₋₁₁, and C₃₋₁₂. Saturated monocyclic cycloalkyl rings include, for example, cyclopropyl, cyclobutyl, cyclopentyl, cyclohexyl, and cyclooctyl. Saturated bicyclic and polycyclic cycloalkyl rings include, for example, norbornane, [2.2.2]bicyclooctane, decahydronaphthalene and adamantane.

Cycloalkyl groups can also be partially unsaturated, having one or more double or triple bonds in the ring. Representative cycloalkyl groups that are partially unsaturated include, but are not limited to, cyclobutene, cyclopentene, cyclohexene, cyclohexadiene (1,3- and 1,4-isomers), cycloheptene, cycloheptadiene, cyclooctene, cyclooctadiene (1,3-, 1,4- and 1,5-isomers), norbornene, and norbornadiene. When cycloalkyl is a saturated monocyclic C₃₋₈ cycloalkyl, exemplary groups include, but are not limited to cyclopropyl, cyclobutyl, cyclopentyl, cyclohexyl, cycloheptyl and cyclooctyl. When cycloalkyl is a saturated monocyclic C₃₋₆ cycloalkyl, exemplary groups include, but are not limited to cyclopropyl, cyclobutyl, cyclopentyl, and cyclohexyl. Cycloalkyl groups can be substituted or unsubstituted. Unless otherwise specified, “substituted cycloalkyl” groups can be substituted with one or more groups selected from halo, hydroxy, amino, alkylamino, amido, acyl, nitro, cyano, and alkoxy. The term “lower cycloalkyl” refers to a cycloalkyl radical having from three to seven carbons including, for example, cyclopropyl, cyclobutyl, cyclopentyl, cyclohexyl, and cycloheptyl.

As used herein, the term “heteroalkyl” refers to an alkyl group as described above wherein at least on carbon atom is replaced with a heteroatom such as N, O or S. Additional heteroatoms can also be useful, including, but not limited to, B, Al, Si and P. The heteroatoms can be oxidized to form moieties such as, but not limited to, —S(O)— and —S(O)₂—.

As used herein, the terms “halo” and “halogen,” by themselves or as part of another substituent, refer to a fluorine, chlorine, bromine, or iodine atom.

As used herein, the term “aryl,” by itself or as part of another substituent, refers to an aromatic ring system having any suitable number of carbon ring atoms and any suitable number of rings. Aryl groups can include any suitable number of carbon ring atoms, such as C₆, C₇, C₈, C₉, C₁₀, C₁₁, C₁₂, C₁₃, C₁₄, C₁₅ or C₁₆, as well as C₆₋₁₀, C₆₋₁₂, or C₆₋₁₄. Aryl groups can be monocyclic, fused to form bicyclic (e.g., benzocyclohexyl) or tricyclic groups, or linked by a bond to form a biaryl group. Representative aryl groups include phenyl, naphthyl and biphenyl. Other aryl groups include benzyl, having a methylene linking group. Some aryl groups have from 6 to 12 ring members, such as phenyl, naphthyl or biphenyl. Other aryl groups have from 6 to 10 ring members, such as phenyl or naphthyl. Some other aryl groups have 6 ring members, such as phenyl. Aryl groups can be substituted or unsubstituted. Unless otherwise specified, “substituted aryl” groups can be substituted with one or more groups selected from halo, hydroxy, amino, alkylamino, amido, acyl, nitro, cyano, and alkoxy.

As used herein, the term “heteroaryl,” by itself or as part of another substituent, refers to a monocyclic or fused bicyclic or tricyclic aromatic ring assembly containing 5 to 16 ring atoms, where from 1 to 5 of the ring atoms are a heteroatom such as N, O or S. Additional heteroatoms can also be useful, including, but not limited to, B, Al, Si and P. The heteroatoms can be oxidized to form moieties such as, but not limited to, —S(O)— and —S(O)₂—. Heteroaryl groups can include any number of ring atoms, such as C₅₋₆, C₃₋₈, C₄₋₈, C₅₋₈, C₆₋₈, C₃₋₉, C₃₋₁₀, C₃₋₁₁, or C₃₋₁₂, wherein at least one of the carbon atoms is replaced by a heteroatom. Any suitable number of heteroatoms can be included in the heteroaryl groups, such as 1, 2, 3, 4; or 5, or 1 to 2, 1 to 3, 1 to 4, 1 to 5, 2 to 3, 2 to 4, 2 to 5, 3 to 4, or 3 to 5. For example, heteroaryl groups can be C₅₋₈ heteroaryl, wherein 1 to 4 carbon ring atoms are replaced with heteroatoms; or C₅₋₈ heteroaryl, wherein 1 to 3 carbon ring atoms are replaced with heteroatoms; or C₅₋₆ heteroaryl, wherein 1 to 4 carbon ring atoms are replaced with heteroatoms; or C₅₋₆ heteroaryl, wherein 1 to 3 carbon ring atoms are replaced with heteroatoms. The heteroaryl group can include groups such as pyrrole, pyridine, imidazole, pyrazole, triazole, tetrazole, pyrazine, pyrimidine, pyridazine, triazine (1,2,3-, 1,2,4- and 1,3,5-isomers), thiophene, furan, thiazole, isothiazole, oxazole, and isoxazole. The heteroaryl groups can also be fused to aromatic ring systems, such as a phenyl ring, to form members including, but not limited to, benzopyrroles such as indole and isoindole, benzopyridines such as quinoline and isoquinoline, benzopyrazine (quinoxaline), benzopyrimidine (quinazoline), benzopyridazines such as phthalazine and cinnoline, benzothiophene, and benzofuran. Other heteroaryl groups include heteroaryl rings linked by a bond, such as bipyridine. Heteroaryl groups can be substituted or unsubstituted. Unless otherwise specified, “substituted heteroaryl” groups can be substituted with one or more groups selected from halo, hydroxy, amino, alkylamino, amido, acyl, nitro, cyano, and alkoxy.

The heteroaryl groups can be linked via any position on the ring. For example, pyrrole includes 1-, 2- and 3-pyrrole, pyridine includes 2-, 3- and 4-pyridine, imidazole includes 1-, 2-, 4- and 5-imidazole, pyrazole includes 1-, 3-, 4- and 5-pyrazole, triazole includes 1-, 4- and 5-triazole, tetrazole includes 1- and 5-tetrazole, pyrimidine includes 2-, 4-, 5- and 6-pyrimidine, pyridazine includes 3- and 4-pyridazine, 1,2,3-triazine includes 4- and 5-triazine, 1,2,4-triazine includes 3-, 5- and 6-triazine, 1,3,5-triazine includes 2-triazine, thiophene includes 2- and 3-thiophene, furan includes 2- and 3-furan, thiazole includes 2-, 4- and 5-thiazole, isothiazole includes 3-, 4- and 5-isothiazole, oxazole includes 2-, 4- and 5-oxazole, isoxazole includes 3-, 4- and 5-isoxazole, indole includes 1-, 2- and 3-indole, isoindole includes 1- and 2-isoindole, quinoline includes 2-, 3- and 4-quinoline, isoquinoline includes 1-, 3- and 4-isoquinoline, quinazoline includes 2- and 4-quinazoline, cinnoline includes 3- and 4-cinnoline, benzothiophene includes 2- and 3-benzothiophene, and benzofuran includes 2- and 3-benzofuran.

As used herein the term “heterocyclyl,” by itself or as part of another substituent, refers to a saturated ring system having from 3 to 12 ring members and from 1 to 4 heteroatoms of N, O and S. Additional heteroatoms can also be useful, including, but not limited to, B, Al, Si and P. The heteroatoms can be oxidized to form moieties such as, but not limited to, —S(O)— and —S(O)₂—. Heterocyclyl groups can include any number of ring atoms, such as, C₃₋₆, C₄₋₆, C₅₋₆, C₃₋₈, C₄₋₈, C₅₋₈, C₆₋₈, C₃₋₉, C₃₋₁₀, C₃₋₁₁, or C₃₋₁₂, wherein at least one of the carbon atoms is replaced by a heteroatom. Any suitable number of carbon ring atoms can be replaced with heteroatoms in the heterocyclyl groups, such as 1, 2, 3, or 4, or 1 to 2, 1 to 3, 1 to 4, 2 to 3, 2 to 4, or 3 to 4. The heterocyclyl group can include groups such as aziridine, azetidine, pyrrolidine, piperidine, azepane, azocane, quinuclidine, pyrazolidine, imidazolidine, piperazine (1,2-, 1,3- and 1,4-isomers), oxirane, oxetane, tetrahydrofuran, oxane (tetrahydropyran), oxepane, thiirane, thietane, thiolane (tetrahydrothiophene), thiane (tetrahydrothiopyran), oxazolidine, isoxazolidine, thiazolidine, isothiazolidine, dioxolane, dithiolane, morpholine, thiomorpholine, dioxane, or dithiane. The heterocyclyl groups can also be fused to aromatic or non-aromatic ring systems to form members including, but not limited to, indoline. Heterocyclyl groups can be unsubstituted or substituted. Unless otherwise specified, “substituted heterocyclyl” groups can be substituted with one or more groups selected from halo, hydroxy, amino, oxo (=O), alkylamino, amido, acyl, nitro, cyano, and alkoxy.

The heterocyclyl groups can be linked via any position on the ring. For example, aziridine can be 1- or 2-aziridine, azetidine can be 1- or 2-azetidine, pyrrolidine can be 1-, 2- or 3-pyrrolidine, piperidine can be 1-, 2-, 3- or 4-piperidine, pyrazolidine can be 1-, 2-, 3-, or 4-pyrazolidine, imidazolidine can be 1-, 2-, 3- or 4-imidazolidine, piperazine can be 1-, 2-, 3- or 4-piperazine, tetrahydrofuran can be 1- or 2-tetrahydrofuran, oxazolidine can be 2-, 3-, 4- or 5-oxazolidine, isoxazolidine can be 2-, 3-, 4- or 5-isoxazolidine, thiazolidine can be 2-, 3-, 4- or 5-thiazolidine, isothiazolidine can be 2-, 3-, 4- or 5-isothiazolidine, and morpholine can be 2-, 3- or 4-morpholine.

As used herein, the term “amino” refers to a moiety —NR₂, wherein each R group is H or alkyl. An amino moiety can be ionized to form the corresponding ammonium cation.

As used herein, the term “hydroxy” refers to the moiety —OH.

As used herein, the term “cyano” refers to a carbon atom triple-bonded to a nitrogen atom (i.e., the moiety —C≡N).

As used herein, the term “amido” refers to a moiety —NRC(O)R or —C(O)NR₂, wherein each R group is H or alkyl.

As used herein, the term “nitro” refers to the moiety —NO₂.

As used herein, the term “oxo” refers to an oxygen atom that is double-bonded to a compound (i.e., O=).

### II. Methods for Cultivating Plants

Provided herein are methods for cultivation of plants. The methods include contacting a plant with an effective amount of a compound according to Formula I:

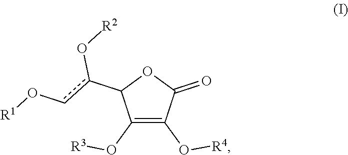

or a salt or solvate thereof, wherein:
[symbol] is either a single or double bond;
R¹ and R² are independently selected from the group consisting of H, C₁₋₆ alkyl, C₁₋₆ alkyl-diol, 2- to 6-membered heteroalkyl, C₃₋₈ cycloalkyl, C₆₋₁₀ aryl, (C₆₋₁₀ aryl)-C₆₋₁₀ alkyl, 5- to 12-membered heteroaryl, (5- to 12-membered heteroaryl)-C₆₋₁₀ alkyl, 5- to 12-membered heterocyclyl, —C(O)R⁵, —C(O)₂R⁵, —C(O)N(R⁵)₂, —S(O)R⁵, and —S(O)₂R⁵;
R¹ and R² are optionally taken together with the oxygen atoms to which they are attached to form a ring which is optionally substituted with one or more R⁶ groups or R⁷ groups;
R³ and R⁴ are independently selected from the group consisting of phosphate, hydrogen phosphate, monohydrogen phosphate, and dihydrogen phosphate, H, C₁₋₆ alkyl, C₁₋₆ alkyl-diol, 2- to 6-membered heteroalkyl, C₃₋₈ cycloalkyl, C₆₋₁₀ aryl, (C₆₋₁₀ aryl)-C₆₋₁₀ alkyl, 5- to 12-membered heteroaryl, (5- to 12-membered heteroaryl)-C₆₋₁₀ alkyl, 5- to 12-membered heterocyclyl, —C(O)R⁵, —C(O)₂R⁵, —C(O)N(R⁵)₂, —S(O)R⁵, and —S(O)₂R⁵;
each R⁵ is independently selected from the group consisting of H, C₁₋₆ alkyl, 2- to 6-membered heteroalkyl, C₃₋₈ cycloalkyl, C₆₋₁₀ aryl, hydroxy-(C₆₋₁₀ aryl), (C₆₋₁₀ aryl)-C₆₋₁₀ alkyl, 5- to 12-membered heteroaryl, (5- to 12-membered heteroaryl)-C₆₋₁₀ alkyl, 5- to 12-membered heterocyclyl, and 5- to 12-membered substituted heterocyclyl;
each R⁶ and R⁷ is independently selected from the group consisting of H, halo, amino, hydroxy, —OR⁵, —N(R⁵)₂, C₁₋₆ alkyl, 2- to 6-membered heteroalkyl, C₃₋₈ cycloalkyl, C₆₋₁₀ aryl, (C₆₋₁₀ aryl)-C₆₋₁₀ alkyl, 5- to 12-membered heteroaryl, (5- to 12-membered heteroaryl)-C₆₋₁₀ alkyl, and 5- to 12-membered heterocyclyl.

In some embodiments, R¹ and R² are taken together with the oxygen atoms to which they are attached to form the ring which is optionally substituted with one or more R⁶ groups or R⁷ groups. In some embodiments, R¹ and R² are taken together with the oxygen atoms to which they are attached to form a 1,3-dioxolane ring. In some embodiments, R¹ and R² are taken together with the oxygen atoms to which they are attached to form a 1,3-dioxolane ring and R⁶ and R⁷ are H. In some embodiments, R¹ and R² are taken together with the oxygen atoms to which they are attached to form a 1,3-dioxolane ring and R⁶ and R⁷ are C₁₋₆ alkyl. In some embodiments, R¹ and R² are taken together with the oxygen atoms to which they are attached to form a 1,3-dioxolane ring and R⁶ and R⁷ are methyl. In some embodiments, R¹ and R² are taken together with the oxygen atoms to which they are attached to form a 1,4-dioxane ring. In some embodiments, R¹ and R² are taken together with the oxygen atoms to which they are attached to form a 1,4-dioxane ring and R⁶ and R⁷ are H. In some embodiments, R¹ and R² are taken together with the oxygen atoms to which they are attached to form a 1,4-dioxane ring and R⁶ and R⁷ are C₁₋₆ alkyl. In some embodiments, R¹ and R² are taken together with the oxygen atoms to which they are attached to form a 1,4-dioxane ring and R⁶ and R⁷ are methyl.

In some embodiments, one or more of R¹, R², R³, and R⁴ are not H. In some embodiments, none of R¹, R², R³, and R⁴ are H. In some embodiments, one or more of R¹, R², R³, and R⁴ are C₁₋₆ alkyl. In some embodiments, each of R¹, R², R³, and R⁴ are C₁₋₆ alkyl. In some embodiments, one or more of R¹, R², R³, and R⁴ are methyl. In some embodiments, each of R¹, R², R³, and R⁴ are methyl. In some embodiments, [symbol] is a double bond. In some embodiments, [symbol] is a single bond.

In some embodiments, the compound is a compound according to Formula II:

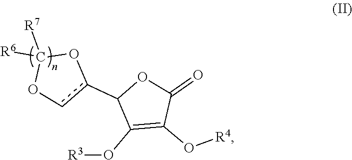

or a salt or solvate thereof,
wherein subscript n is 1, 2, 3, or 4.

In some embodiments, R³, R⁴, each R⁶, and each R⁷ are independently selected from the group consisting of H and C₁₋₆ alkyl. In some embodiments, R³, R⁴, each R⁶, and each R⁷ are independently C₁₋₆ alkyl. In some embodiments, R³, R⁴, each R⁶, and each R⁷ are independently C₁₋₆ alkyl-diol. In some embodiments, R³, R⁴, each R⁶, and each R⁷ are independently selected from the group consisting of methyl, ethyl, n-propyl, iso-propyl, n-butyl, sec-butyl, iso-butyl, and tert-butyl. In some embodiments, R³, R⁴, each R⁶, and each R⁷ are methyl. In some embodiments, [symbol] is a double bond. In some embodiments, [symbol] is a single bond.

In some embodiments, the compound is a compound according to Formula III:

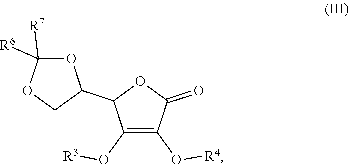

or a salt or solvate thereof.

In some embodiments, R³, R⁴, each R⁶, and each R⁷ are independently selected from the group consisting of H and C₁₋₆ alkyl. In some embodiments, R³, R⁴, each R⁶, and each R⁷ are independently C₁₋₆ alkyl. In some embodiments, R³, R⁴, each R⁶, and each R⁷ are independently C₁₋₆ alkyl-diol. In some embodiments, R³, R⁴, each R⁶, and each R⁷ are independently selected from the group consisting of methyl, ethyl, n-propyl, iso-propyl, n-butyl, sec-butyl, iso-butyl, and tert-butyl. In some embodiments, R³, R⁴, each R⁶, and each R⁷ are methyl.

In some embodiments, the compound is a compound according to Formula IV:

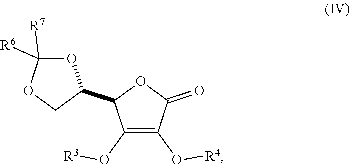

or a salt or solvate thereof.

In some embodiments, R³, R⁴, each R⁶, and each R⁷ are independently selected from the group consisting of H and C₁₋₆ alkyl. In some embodiments, R³, R⁴, each R⁶, and each R⁷ are independently C₁₋₆ alkyl. In some embodiments, R³, R⁴, each R⁶, and each R⁷ are independently C₁₋₆ alkyl-diol. In some embodiments, R³, R⁴, each R⁶, and each R⁷ are independently selected from the group consisting of methyl, ethyl, n-propyl, iso-propyl, n-butyl, sec-butyl, iso-butyl, and tert-butyl. In some embodiments, R³, R⁴, each R⁶, and each R⁷ are methyl.

In some embodiments, the compound is a compound according to Formula V:

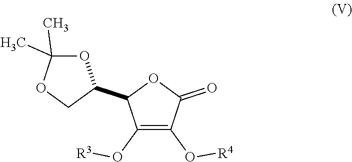

or a salt or solvate thereof,
wherein R³ and R⁴ are independently C₁₋₆ alkyl.

In some embodiments, the compound is a compound according to Formula VI:

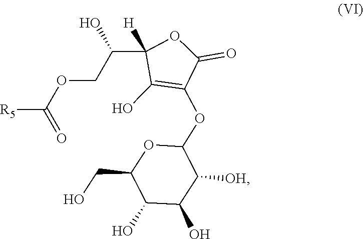

or a salt or solvate thereof.

In some embodiments, the compound is a compound according to a Formula selected from:

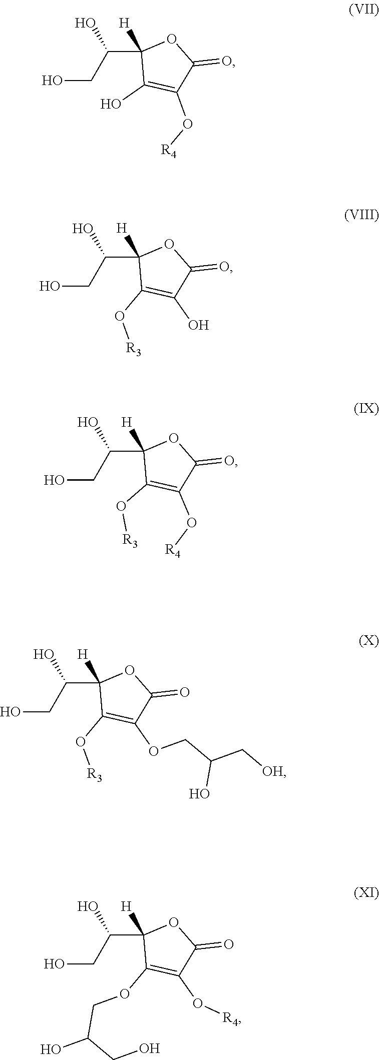

or a salt or solvate thereof.

In some embodiments, the compound is a compound according to a Formula selected from:

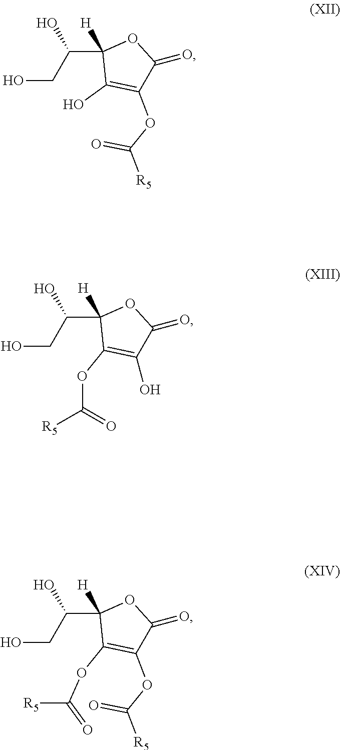

or a salt or solvate thereof.

In some embodiments, R³ and R⁴ are independently selected from the group consisting of H and C₁₋₆ alkyl. In some embodiments, R³ and R⁴ are independently C₁₋₆ alkyl. In some embodiments, R³, and R⁴ are independently C₁₋₆ alkyl-diol. In some embodiments, R³ and R⁴ are independently selected from the group consisting of methyl, ethyl, n-propyl, iso-propyl, n-butyl, sec-butyl, iso-butyl, and tert-butyl. In some embodiments, R³ and R⁴ are independently selected from phosphate, hydrogen phosphate, monohydrogen phosphate, and dihydrogen phosphate. In some embodiments the compound is (5R)-5-(2,2-dimethyl-1,3-dioxolan-4-yl)-3,4-dimethoxyfuran-2(5H)-one (“Compound 1”).

In some embodiments, R¹, R², R³, and R⁴ are independently selected from the group consisting of H and C₁₋₆ alkyl. In some such embodiments, R¹, R², R³, and R⁴ are independently C₁₋₆ alkyl. In some such embodiments, R¹, R², R³, and R⁴ are independently C₁₋₆ alkyl-diol. In some embodiments, each of R¹, R², R³, and R⁴ are independently selected from the group consisting of methyl, ethyl, n-propyl, iso-propyl, n-butyl, sec-butyl, iso-butyl, and tert-butyl. In some embodiments, each of R¹, R², R³, and R⁴ are methyl.

In some embodiments, the compound of Formula I, II, III, IV, V, VI, VII, VIII, IX, X, XI, XII, XIII, and/or XIV is not ascorbic acid.

In some embodiments, the compound of Formula I, II, III, IV, V, VI, VII, VIII, IX, X, and/or XI is selected from:

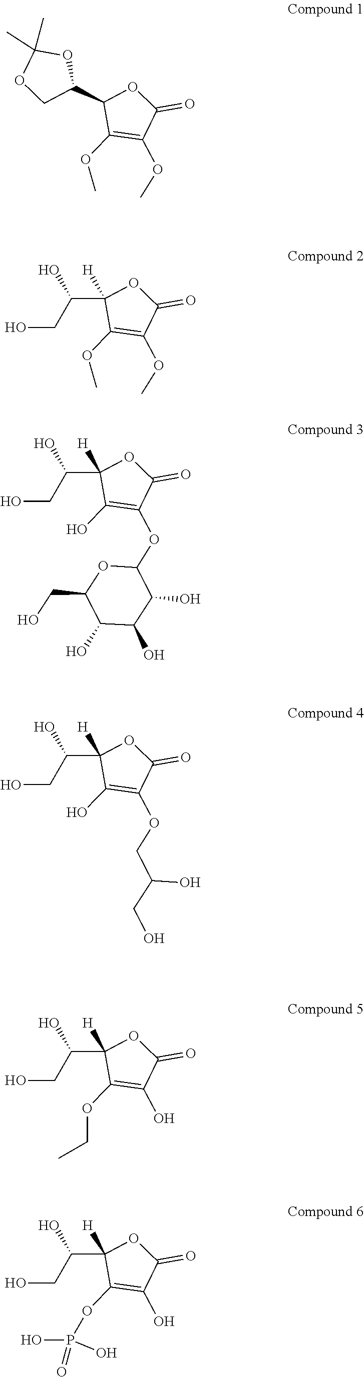 [SMILES: COC1=C(OC)[C@@H]([C@@H]2COC(C)(C)O2)OC1=O ; COC1=C(OC)[C@@H]([C@@H](O)CO)OC1=O ; O=C1O[C@@H]([C@@H](O)CO)C(O)=C1OC1O[C@H](CO)[C@@H](O)[C@H](O)[C@H]1O ; O=C1O[C@@H]([C@@H](O)CO)C(O)=C1OCC(O)CO ; CCOC1=C(O)C(=O)O[C@H]1[C@@H](O)CO ; O=C1O[C@@H]([C@@H](O)CO)C(OP(=O)(O)O)=C1O]

In some embodiments, the effective amount of a compound to be used for cultivating a plant is greater than or equal to 1 gram/acre. In some embodiments, the effective amount of a compound to be used for cultivating a plant does not exceed 4000 g/acre. In some embodiments, the effective amount to be used for cultivating a plant is 1, 10, 100, or 1000 g/acre. In some embodiments, the effective amount to be used for cultivating a plant is 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1010, 1020, 1030, 1040, 1050, 1060, 1070, 1080, 1090, 1100, 1110, 1120, 1130, 1140, 1150, 1160, 1170, 1180, 1190, 1200, 1210, 1220, 1230, 1240, 1250, 1260, 1270, 1280, 1290, 1300, 1310, 1320, 1330, 1340, 1350, 1360, 1370, 1380, 1390, 1400, 1410, 1420, 1430, 1440, 1450, 1460, 1470, 1480, 1490, 1500, 1510, 1520, 1530, 1540, 1550, 1560, 1570, 1580, 1590, 1600, 1610, 1620, 1630, 1640, 1650, 1660, 1670, 1680, 1690, 1700, 1710, 1720, 1730, 1740, 1750, 1760, 1770, 1780, 1790, 1800, 1810, 1820, 1830, 1840, 1850, 1860, 1870, 1880, 1890, 1900, 1910, 1920, 1930, 1940, 1950, 1960, 1970, 1980, 1990, 2000, 2010, 2020, 2030, 2040, 2050, 2060, 2070, 2080, 2090, 2100, 2110, 2120, 2130, 2140, 2150, 2160, 2170, 2180, 2190, 2200, 2210, 2220, 2230, 2240, 2250, 2260, 2270, 2280, 2290, 2300, 2310, 2320, 2330, 2340, 2350, 2360, 2370, 2380, 2390, 2400, 2410, 2420, 2430, 2440, 2450, 2460, 2470, 2480, 2490, 2500, 2510, 2520, 2530, 2540, 2550, 2560, 2570, 2580, 2590, 2600, 2610, 2620, 2630, 2640, 2650, 2660, 2670, 2680, 2690, 2700, 2710, 2720, 2730, 2740, 2750, 2760, 2770, 2780, 2790, 2800, 2810, 2820, 2830, 2840, 2850, 2860, 2870, 2880, 2890, 2900, 2910, 2920, 2930, 2940, 2950, 2960, 2970, 2980, 2990, 3000, 3010, 3020, 3030, 3040, 3050, 3060, 3070, 3080, 3090, 3100, 3110, 3120, 3130, 3140, 3150, 3160, 3170, 3180, 3190, 3200, 3210, 3220, 3230, 3240, 3250, 3260, 3270, 3280, 3290, 3300, 3310, 3320, 3330, 3340, 3350, 3360, 3370, 3380, 3390, 3400, 3410, 3420, 3430, 3440, 3450, 3460, 3470, 3480, 3490, 3500, 3510, 3520, 3530, 3540, 3550, 3560, 3570, 3580, 3590, 3600, 3610, 3620, 3630, 3640, 3650, 3660, 3670, 3680, 3690, 3700, 3710, 3720, 3730, 3740, 3750, 3760, 3770, 3780, 3790, 3800, 3810, 3820, 3830, 3840, 3850, 3860, 3870, 3880, 3890, 3900, 3910, 3920, 3930, 3940, 3950, 3960, 3970, 3980, 3990, or 4000 g/acre. In some embodiments, the effective amount of a compound to be used for cultivating a plant is within the range of 1 g/acre and 4000 g/acre. In some embodiments, the effective amount of a compound to be used for cultivating a plant is 4 g/acre to 20 g/acre. In some embodiments, the effective amount of a compound to be used for cultivating a plant is 40 g/acre to 200 g/acre. In some embodiments, the effective amount of a compound to be used for cultivating a plant is 400 g/acre to 2000 g/acre.

### III. Formulations for Agricultural Applications

In some embodiments, the present disclosure provides formulations comprising the compound according to Formula I, II, III, IV, V, VI, VII, VIII, IX, X, XI, XII, XIII, or XIV or a salt or solvate thereof. In some embodiments, the formulation is an agricultural formulation. In some embodiments, the formulation comprises the compound of Formula I, II, III, IV, V, VI, VII, VIII, IX, X, XI, XII, XIII, or XIV at a concentration ranging from about 0.1% to about 50% w/w. For example, the compound is present at a concentration of about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%. In some embodiments, the compound may be present at a range from about 0.1% to about 30% w/w, about 1% to about 25% w/w, about 10% to about 30% w/w, about 20% to about 30% w/w, about 15% to about 50% w/w, about 30% to about 50% w/w, about 30% to about 40% w/w, about 10% to about 15% w/w, about 10% to about 20% w/w, about 1% to about 10% w/w, about 1% to about 5% w/w, or about 5% to about 10% w/w. In some embodiments, the formulation comprises the compound of Formula I, II, III, IV, V, VI, VII, VIII, IX, X, XI, XII, XIII, or XIV at a concentration ranging from about 1 to about 300 g/L. For example, the agricultural formulation comprises the compound of Formula I, II, III, IV, V, VI, VII, VIII, IX, X, XI, XII, XIII, or XIV at a concentration of about 1, about 2, about 3, about 4, about 5, about 6, about 7, about 8, about 9, about 10, about 15, about 20, about 25, about 30, about 35, about 40, about 45, about 50, about 55, about 60, about 65, about 70, about 75, about 80, about 85, about 90, about 95, about 100, about 105, about 110, about 115, about 120, about 125, about 130, about 135, about 140, about 145, about 150, about 155, about 160, about 165, about 170, about 175, about 180, about 185, about 190, about 195, about 200, about 205, about 210, about 215, about 220, about 225, about 230, about 235, about 240, about 245, about 250, about 255, about 260, about 265, about 270, about 275, about 280, about 285, about 290, about 295, or about 300 g/L. In some embodiments, the agricultural formulation comprises the compound of Formula I, II, III, IV, V, VI, VII, VIII, IX, X, XI, XII, XIII, or XIV at a concentration ranging from about 1 to about 300 g/L, about 10 to about 250, about 20 to about 200, about 25 to about 200, about 50 to about 200, about 75 to about 200, about 100 to about 200, about 150 to about 200, about 175 to about 200, about 50 to about 300, about 50 to about 250, about 50 to about 200, about 50 to about 150, about 50 to about 100, about 100 to about 300, about 100 to about 250, about 100 to about 200, about 100 to about 150, about 150 to about 300, about 150 to about 250, or about 150 to about 200 g/L.

In some embodiments, with the formulation is an agricultural formulation comprising the compound, or a salt or solvate thereof, and an agriculturally acceptable carrier. In some embodiments, the carrier is an aqueous carrier. In some embodiments, the carrier is non-aqueous carrier. Carriers suitable for use in the present invention include, but are not limited to, water, propylene glycol, dipropylene glycol, butyl glycol, ethylene glycol, diethylene glycol, triethylphosphate, triethylene glycol, Isopropylidene glycerol, tetraethylene glycol, oils such as soy bean oil, corn oil, sunflower oil, vegetable oil, peanut oil, and canola oil, an alcohol including a monohydric, dihydric or trihydric alcohol such as propanol, isopropanol, a 1:1 mixture of (cis, trans) 1,3-cyclohexanedimethanol and (cis, trans) 1,4-cyclohexanedimethanol (Unoxol® Diol; Unoxol is a registered trademark of and available from Union Carbide Chemicals & Plastics Technology Corporation), 1,3-propane diol, Methyl 5-(dimethylamino)-2-methyl-5-oxopentanoate, 1,3-butanediol, 1,4-butanediol, 1,5-pentanediol, 3-methyl-1,5-pentanediol, 2,4-diethyl-1,5-pentanediol, 2,4,4-trimethylhexane-1,6-diol, butenediol, butynediol, Dihydrolevoglucosenone, pentanediol, hexanediol, octanediol, neopentyl glycol, 2-methyl-1,3-propanediol, 1,3-propanediol, dibutylene glycol, butylene glycol, hexylene glycol, 1,4-cyclohexanedimethanol, 1,3-dihydroxy-2-methylpropane, butane-1,2,3-triol, butane-1,2,4-triol, hexane-1,2,6-triol and the like, a polyalkylene glycol such as polyethylene glycol, polypropylene glycol, polybutylene glycol, methoxy polyethylene glycol and the like, glycerol, polyglycerol, a glycol ether including a propylene or ethylene derivative of glycol ether such as propylene glycol methyl ether, glycerol carbonate, dipropylene glycol methyl ether, tripropylene glycol methyl ether, propylene glycol n-propyl ether, ethylene glycol n-propyl ether, ethylene glycol n-butyl ether, diethylene glycol monomethyl ether, diethylene glycol ethyl ether, triethylene glycol methyl ether and the like, a sugar alcohol such as sorbitol and the like, a carbonate solvent such as ethylene carbonate, propylene carbonate, butyl lactate, triethyl citrate, butylene carbonate and the like, dimethyl sulfoxide, an alkyl alkoxylate including fatty alcohol ethoxylate (Emulan™ TXI (Emulan is available from BASF), an alkyl EO/PO (ethylene oxide (EO), propylene oxide (PO)) and the like, an alkyl ester such as the ester of 2-ethyl hexanol and natural lactic acid (Agnique® AE 3-2EH; Agnique is a registered trademark of Cognis IP Management Gmbh Corporation), Agnique® AMD 3L, gamma-butyrolactone, butyl lactate, ethyl lactate and the like, an acid such as propionic acid, a hydroxy acid such as lactic acid or glycolic acid and the like, a dimethyl amide solvent such as C8-C10 alkyl amide, dimethyl lactamide and the like, an esteramide such as N, N-dimethylcaprylamide, N, N-dimethyl 9-decenamide and the like, a pyrrolidone such as N-methyl-2-pyrrolidone, 1-butylpyrrolidin-2-one, 2-pyrrolidone N-cyclohexyl-pyrrolidone and the like, triacetin, monoacetin, 2-Ethylhexyl lactate, Glyceryl triacetate, dimethylformamide, tetrahydrofuran, dimethylacetamide, N-formylmorpholine, Triethyl 0-acetylcitrate, Tributyl 0-acetylcitrate, Methyl isobutyl glycerol formal, Capryl/capric acid dimethylamide, 4,5-Dihydro-5-methyl-2(3H)-furanone, diisopropyl amine and tetramethylurea. Carriers for use in the present invention may be present at a concentration from about 1% to about 99% w/w, for example at a concentration of about 1%, about 2%, about 3%, about 4%, about 5%, about 6%, about 7%, about 8%, about 9%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 99%. In some embodiments, the carrier is present in a concentration ranging from about 50% to about 95% w/w, or from about 50% to about 80% w/w, or from about 50% to about 70% w/w, or from about 50% to about 70% w/w or from about 60% to about 80% w/w, or from about 70% to about 90% w/w, or from about 70% to about 80% w/w, or from about 80% to about 90% w/w.

In some embodiments, the agricultural formulation further comprises a surfactant. Surfactants suitable for use in the present invention include, but not are not limited to, surfactants sold under the trade names Tween® including 20-24 and the like (Tween is a registered trademark of and available from Uniqema), Span™ including 20-80 (Span is available from Croda Americas LLC), Agnique®, Tomadol®, Brij® including 020, C10, C2, C20, L4, L23 and 520, (Brij is a registered trademark of Croda Americas LLC), Synperonic® including PE/F series, Atlox® including 4991, MBA 11/8, 775, 3484, 4912, Metasperse, 4913, 671, 793, 3467, AL-3273 and 3416, Cresmer™ including A2 (Cresmer is available from Croda Americas LLC), Ecosurf™ including EH-14, SA-15 and LF45 (Ecosurf is available from Dow Inc.), Toximul® including 8315, 8320, 8323, 8325, 8304, CA 7.5, TA-15, 8240 and DM-83, Makon® including 14, TD and TSP-25 (Makon is a registered trademark of and available from Stepan Company Corporation), Lutensol® (Lutensol is a registered trademark of and available from BASF Aktiengesellschaft Corporation), Tergitol™ including XJ, XH, 15 s-9, 15 s20, TMN-10 and L-64, Triton including X-100, X114, CG-50, H-55 and GR-5M (Triton is available from Dow Inc.), Lissapol including PA (Lissapol is available from Croda Americas LLC, Step-Flow® including 26, Pluronic® (Pluronic is a registered trademark of and available from BASF Corporation), Ultraric® including PE (Ultraric is a registered trademark of and available from OXITENO S.A.), Alkest® including E 100 (Alkest is a registered trademark of and available from OXITENO S.A.), Alkamul® (Alkamul is a registered trademark of and available from Rhodia Operations Corporation), Cithrol (available from Croda Americas LLC), Myrj® (Myrj is a registered trademark of and available from Croda Americas LLC), Ninex® including MT (Ninex is a registered trademark of and available from Stepan Company Corporation), Cirrasol® including G-1282 (Cirrasol is a registered trademark of and available from Croda International PLC), Etocas including 32 (Etocas is available from Croda Americas LLC), Stepsperse® including DF-200 and DF-600 (Stepserse is a registered trademark of and available from Stepan Company Corporation), Multitrope including 1214 and 1620 (Multitrope is available from Croda Americas LLC), Cresplus including DP and 1209 (Cresplus is available from Croda Americas LLC), Silwet® (Silwet is a registered trademark of and available from Momentive Performance Materials Inc.), Break-Thru® (Break-thru is a registered trademark of and available from Evonik Degussa GMBH), Xiameter® including OFX-5211 (Xiameter is a registered trademark of and available from Dow Inc.), Crodafos (Crodafos is available from Croda Americas LLC), Stepfac™ including 8715 (Stepfac is available from Stepan Company Corporation), Agrilan® including 1028 (Agrilan is a registered trademark of and available from Akzo Nobel Chemicals International), Dowfax™ including 3B2 (Dowfax is available from Dow, Inc.), Stepwet® including DF-95 (Stepwet is a registered trademark of and available from Stepan Company Corporation), Ninate® including 60E (Ninate is a registered trademark of and available from Stepan Company Corporation), Bio-Terge® including AS-40 (Bio-terge is a registered trademark of and available from Stepan Company Corporation), Polystep® including B-27 (Polystep is a registered trademark of and available from Stepan Company Corporation), Steol® including TSP-16N and CS-370 (Steol is a registered trademark of and available from Stepan Company Corporation), Morwet® (Morwet is a registered trademark of and available from Akzo Nobel Chemicals International), Powerblox™ including SN (Powerblox is available from Dow, Inc.), Dispersol including F CONC and SC 873 (Dispersol is available from Croda Americas LLC), Aerosol® including OT-B (Aerosol is a registered trademark of Cytec Technology Corp and available from Solvay), Multiwet (Multiwet is available from Croda Americas LLC), Zephrym® including PD3315 (Zephrym is a registered trademark of and available from Uniqema Americas LLC), Sil-MES® including 100 (Sil-MES is a registered trademark of and available from Drexel Chemical Company), Atplus® including 309F (Atplus is a registered trademark of and available from Croda Americas LLC), Micro-step including H-303 (Micro-step is available from Stepan Company Corporation) and Crodateric including TO (Crodateric is available from Croda Americas LLC) and Alcolec® (Alcolec is a registered trademark of and available from American Lecithin Company). Surfactants for use in the formulations of the present invention may be present at a concentration from about 0.1% to about 10% w/w. For example, the surfactant is present at a concentration of about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, or about 10%. In some embodiments, the surfactant concentration may range from about 0.1% to about 5% w/w, about 1% to about 5% w/w, about 1% to about 3% w/w, about 1% to about 2% w/w, about 2% to about 5% w/w.

In some embodiments, the agricultural formulation further comprises a dispersing agent, a wetting agent, a thickener, a stabilizer, a chelator, or combinations thereof.

In some embodiments, the formulations described herein comprise a compound according to Formula I, II, III, IV, V, VI, VII, VIII, IX, X, XI, XII, XIII, or XIV and one or more stabilizers and/or other additives. The stabilizers and/or additives can include, but are not limited to, penetration agents, adhesives, anticaking agents, chelators, dyes, dispersing agents, wetting agents, emulsifying agents, defoamers, antimicrobials, antifreeze, pigments, colorants, buffers, thickeners, and carriers. The formulations may further comprise surfactants and/or adjuvants.

In some embodiments, the formulations described herein comprise a compound according to Formula I, II, III, IV, V, VI, VII, VIII, IX, X, XI, XII, XIII, or XIV (including compounds according to any of the embodiments described above) and one or more dispersants. The dispersant may be a negatively charged anion dispersant. The dispersant may be a nonionic dispersant.

In some embodiments, the formulations described herein comprise a compound according to Formula I, II, III, IV, V, VI, VII, VIII, IX, X, XI, XII, XIII, or XIV (including compounds according to any of the embodiments described above) and a fertilizer. The fertilizer may be a chemical fertilizer. The fertilizer may be an organic fertilizer. The fertilizer may be an inorganic fertilizer. The fertilizer may be a granulated or powdered fertilizer. The fertilizer may be a liquid fertilizer. The fertilizer may be a slow-release fertilizer.

In some embodiments, the formulation comprises a compound according to Formula I, II, III, IV, V, VI, VII, VIII, IX, X, XI, XII, XIII, or XIV (including compounds according to any of the embodiments described above) and a pesticide. The pesticide may be, for example, an insecticide, a fungicide, a nematicide, a bactericide, an acaricide, a chemosterilant, or a combination thereof.

In some embodiments, the agricultural formulation comprises a compound according to Formula I, II, III, IV, V, VI, VII, VIII, IX, X, XI, XII, XIII, or XIV (including compounds according to any of the embodiments described above) and a bacterium, a virus, a fungus, or a combination thereof. For example, the formulation may contain beneficial bacterial inoculants that aid crops in nitrogen fixation (e.g., Bradyrhizobium spp., Rhizobium spp.), phytohormone production (e.g., Azospirillum spp., Pseudomonas spp.), phosphate solubilization (e.g., Bacillus spp.), and/or biological control (e.g., Pseudomonas spp., Bacillus spp.). Examples of such inoculants include, but are not limited to, those described by Santos, et al. (AMB Expr 2019; 9: 205). Beneficial fungi, including but not limited to endophytic fungi, can be included in the formulations to improve plant properties such as root and seed development; nutrient uptake or absorption; photosynthesis promotion; growth of biomass; increase chlorophyll content; and abiotic stress resistance. Examples of such fungi include, but are not limited to, species of Acremonium, Alternaria, Aspergillus, Chaetomium, Fusarium, and Penicillium. See, e.g., Orgeta et al. (Microorganisms 2020; 8: 1237). Examples of beneficial viruses include, but are not limited to, acute viruses which confer tolerance to temperature extremes (Brome mosaic virus, family Bromoviridae, Cucumber mosaic virus, family Bromoviridae, Tobacco rattle virus, family Virgaviridae, and Tobacco mosaic virus, family Virgaviridae), and persistent viruses such as White clover cryptic virus (family Partitiviridae), which can suppress nodulation in legumes. See, e.g., Roossinck (Mol Plant Pathol. 2015; 16(4): 331-333).

In some embodiments, the agricultural formulation further comprises a compound of formula:

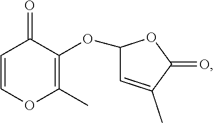 [SMILES: CC1=CC(Oc2c(C)occc2=O)OC1=O]

and salts and solvates thereof. In some embodiments, said compound may be present at a concentration ranging from about 0.1% to about 50% w/w. For example about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%. In some embodiments, said compound is present at a range from about 0.1% to about 30% w/w, about 1% to about 25% w/w, about 10% to about 30% w/w, about 20% to about 30% w/w, about 15% to about 50% w/w, about 30% to about 50% w/w, about 30% to about 40% w/w, about 10% to about 15% w/w, about 10% to about 20% w/w, about 1% to about 10% w/w, about 1% to about 5% w/w, or about 5% to about 10% w/w.

In some embodiments, the agricultural formulation further comprises a compound of formula:

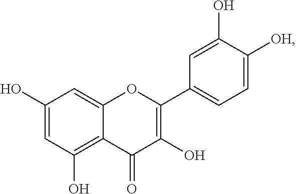 [SMILES: O=c1c(O)c(-c2ccc(O)c(O)c2)oc2cc(O)cc(O)c12]

and salts (e.g., dihydrate) and solvates thereof. In some embodiments, said compound may be present at a concentration ranging from about 0.1% to about 50% w/w. For example about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%. In some embodiments, said compound is present at a range from about 0.1% to about 30% w/w, about 1% to about 25% w/w, about 10% to about 30% w/w, about 20% to about 30% w/w, about 15% to about 50% w/w, about 30% to about 50% w/w, about 30% to about 40% w/w, about 10% to about 15% w/w, about 10% to about 20% w/w, about 1% to about 10% w/w, about 1% to about 50% w/w, or about 50% to about 10% w/w.

In some embodiments, the agricultural formulation further comprises a plant growth regulator (PGR), an insect growth regulator, a microbial growth regulator, or a combination thereof. PGRs can be numerous chemical substances that can influence the growth and/or differentiation of plant cells, tissues, or organs. Plant growth regulators can function as chemical messengers for intercellular communication. PGRs can include auxins (e.g., indole-3-acetic acid, 4-chloroindole-3-acetic acid, phenylacetic acid, indole-3-butyric acid, indole-3-propionic acid, 1-naphthaleneacetic acid, 2,4-dichlorophenoxyacetic acid, and the like), gibberellins (e.g., GA1, GA3, GA4, GA7, GA0, ent-gibberellane, ent-kaurene, and the like), cytokinins (e.g., kinetin, zeatin, 6-benzylaminopurine, diphenylurea, thidiazuron, and the like), abscisic acid, ethylene, brassinosteroids, and polyamines.

In some embodiments, the agricultural formulation is a dispersion concentrate (DC). In some embodiments, the DC comprises a compound according to Formula I, II, III, IV, V, VI, VII, VIII, IX, X, XI, XII, XIII, or XIV (including compounds according to any of the embodiments described above) and a suitable carrier, for example an N,N-dimethyl lactamide (Agnique® AMD 3L). In some embodiments, the agricultural formulation comprises the compound of Formula I, II, III, IV, V, VI, VII, VIII, IX, X, XI, XII, XIII, or XIV at a concentration ranging from 1 to 300 g/L. For example, the agricultural formulation comprises the compound of Formula I, II, III, IV, V, VI, VII, VIII, IX, X, XI, XII, XIII, or XIV at a concentration of 1, 2, 3, 4, 5, 6, 7, 8, 9, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, or 300 g/L. In some embodiments, the agricultural formulation comprises the compound of Formula I, II, III, IV, V, VI, VII, VIII, IX, X, XI, XII, XIII, or XIV at a concentration ranging from 1-300, 10-250, 20-200, 25-200, 50-200, 75-200, 100-200, 150-200, 175-200, 50-300, 50-250, 50-200, 50-150, 50-100, 100-300, 100-250, 100-200, 100-150, 150-300, 150-250, or 150-200 g/L. In some embodiments, the agricultural formulation concentration does not exceed 250 g/L of the compound according to Formula I and Agnique® AMD 3L. In some embodiments, the agricultural formulation concentration does not exceed 300 g/L of the compound according to Formula I and Agnique® AMD 3L. In some embodiments, the compound according to Formula I is Compound 1. In some embodiments, the compound according to Formula I is Compound II.

In some embodiments, the agricultural formulation is an oil dispersion (OD) formulation. In some embodiments, the OD formulation comprises a compound according to Formula I, II, III, IV, V, VI, VII, VIII, IX, X, XI, XII, XIII, or XIV (including compounds according to any of the embodiments described above) and a suitable carrier. In some embodiments, the formulation further comprises a single non-phytotoxic emulsifier system (polyoxyethylene (40) sorbitol hexaoleate, Cirrasol™ G-1086), a nonionic polymeric surfactant with high oil affinity (Hydrophile-Lipophile Balance (HLB) value=6, Atlox™ 4914), an inert powdered gelling grade of attapulgite clay (Attagel® 50), butylated hydroxytoluene (BHT), and sunflower oil. In some embodiments, the agricultural formulation comprises the compound of Formula I, II, III, IV, V, VI, VII, VIII, IX, X, XI, XII, XIII, or XIV at a concentration ranging from 1 to 300 g/L. For example, the agricultural formulation comprises the compound of Formula I, II, III, IV, V, VI, VII, VIII, IX, X, XI, XII, XIII, or XIV at a concentration of 1, 2, 3, 4, 5, 6, 7, 8, 9, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, or 300 g/L. In some embodiments, the agricultural formulation comprises the compound of Formula I, II, III, IV, V, VI, VII, VIII, IX, X, XI, XII, XIII, or XIV at a concentration ranging from 1-300, 10-250, 20-200, 25-200, 50-200, 75-200, 100-200, 150-200, 175-200, 50-300, 50-250, 50-200, 50-150, 50-100, 100-300, 100-250, 100-200, 100-150, 150-300, 150-250, or 150-200 g/L. In some embodiments, the agricultural formulation concentration does not exceed 250 g/L of the compound according to Formula I Cirrasol™ G-1086, Atlox™ 4914, Attagel® 50 and BHT. In some embodiments, the agricultural formulation concentration does not exceed 300 g/L of the compound according to Formula I Cirrasol™ G-1086, Atlox™ 4914, Attagel® 50 and BHT. In some embodiments, the compound according to Formula I is Compound 1. In some embodiments, the compound according to Formula I is Compound II.

In some embodiments, the agricultural formulation further comprises one or more strigolactones, or salts or solvates thereof. Examples of strigolactones include, but are not limited to, strigol, strigyl, strigyl acetate, orobanchol, orobanchyl acetate, 5-deoxystrigol, sorgolactone, 2′-epiorobanchol, sorgomol, solanacol, 7-oxoorobanchol, 7-oxoorobanchol acetate, fabacyl acetate, and GR24 (see, Krasylenko et al. Frontiers in Plant Science, 2021, 12: Article 675981). In some embodiments, the agricultural formulation further comprises (R)-2-methyl-3-((4-methyl-5-oxo-2,5-dihydrofuran-2-yl)oxy)-4H-pyran-4-one, (S)-2-methyl-3-((4-methyl-5-oxo-2,5-dihydrofuran-2-yl)oxy)-4H-pyran-4-one, salts thereof, solvates thereof, or combinations thereof. In some embodiments, the agricultural formulation further comprises quercetin or a salt or solvate thereof. Examples of strigolactones, quercetins, and related compounds are also described in WO 2015/061764, WO 2016/172655, WO 2020/068946, WO 2020/191072, and Intl. Pat. Appl. No. PCT/US2021/035770, which are incorporated herein by reference in their entirety.

### IV. Application to Plants and Soil

In some embodiments, the contacting comprises contacting a leaf of the plant, a stem of the plant, a root of the plant, or combinations thereof. The formulation may be applied to the plant and/or the surrounding soil through sprays, drips, and/or other forms of liquid application. In some embodiments, the formulation is applied as a foliar spray. In some embodiments, the formulation is applied as an aqueous solution. Any conventional atomization method can be used to generate spray droplets, including hydraulic nozzles and rotating disk atomizers. In other instances, alternative application techniques, including application by brush or by rope-wick, may be utilized.

The methods provided herein may be employed in the cultivation of a wide variety of food crops, feed crops, fiber crops, oil crops, ornamental crops, and industrial crops. In some embodiments, the plant is selected from the group consisting of cotton, alfalfa, Arabidopsis, banana, barley, canola, castor bean, chrysanthemum, clover, cocoa, coffee, cottonseed, corn (maize), crambe, cranberry, cucumber, dendrobium, dioscorea, eucalyptus, fescue, flax, gladiolus, liliacea, linseed, millet, muskmelon, mustard, oat, oil palm, oilseed rape, papaya, peanut, pineapple, ornamental plants, Phaseolus, potato, rapeseed, rice, rye, ryegrass, safflower, sesame, sorghum, soybean, sugarbeet, sugarcane, sunflower, strawberry, tobacco, tomato, turfgrass, wheat, vegetable crops such as lettuce, celery, broccoli, cauliflower, cucurbits, onions (including garlic, shallots, leeks, and chives); fruit and nut trees, such as apple, pear, peach, orange, grapefruit, lemon, lime, almond, pecan, walnut, hazel; vines, such as grapes, kiwi, hops; fruit shrubs and brambles, such as raspberry, blackberry, gooseberry; forest trees, such as ash, pine, fir, maple, oak, chestnut, poplar; with alfalfa, canola, castor bean, corn, cotton, crambe, flax, linseed, mustard, oil palm, oilseed rape, peanut, potato, rice, safflower, sesame, soybean, sugarbeet, sugarcane, sunflower, tomato and wheat. In some embodiments, the plant is corn or soybean.

The compounds described herein may penetrate the plant through the roots via the soil (systemic action); by drenching the locus of the plant with a liquid formulation; or by applying the compounds in solid form to the soil, e.g., in granular form (soil application). As used herein, the term “locus” broadly encompasses the fields on which the treated plants are growing, or where the seeds of cultivated plants are sown, or the place where the seed will be placed into the soil.

A furanone compound as described herein may be applied to a plant, including plant leaves, shoots, roots, or seeds. For example, the furanone compound can be applied to a foliar surface of a plant. As used herein, the term “foliar surface” broadly refers to any green portion of a plant having surface that may permit absorption of a formulation as described herein, including petioles, stipules, stems, bracts, flowerbuds, and leaves. Absorption commonly occurs at the site of application on a foliar surface, but in some cases, the compound may spread to other areas and be absorbed there. The furanone compound may also be directly applied to the soil surrounding the root zone of a plant. In some embodiments, plants are contacted by applying a furanone compound as described to an area of cultivation herein in an amount ranging from about 0.5 g to about 100 g per acre. The compound, or salt or solvate thereof, may be employed in an amount of 0.5-1 g/acre, 1-5 g/acre, 1-10 g/acre, 5-10 g/acre, 10-20 g/acre, 20-30 g/acre, 30-40 g/acre, 40-50 g/acre, 50-60 g/acre, 60-70 g/acre, 70-80 g/acre, 80-90 g/acre, or 90-100 g/acre. or a salt or solvate thereof. The compound, or salt or solvate thereof, may be employed in an amount of about 5, 10, 15, 20, or 25 g/acre. The compound, or salt or solvate thereof, may be employed in an amount of about 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1010, 1020, 1030, 1040, 1050, 1060, 1070, 1080, 1090, 1100, 1110, 1120, 1130, 1140, 1150, 1160, 1170, 1180, 1190, 1200, 1210, 1220, 1230, 1240, 1250, 1260, 1270, 1280, 1290, 1300, 1310, 1320, 1330, 1340, 1350, 1360, 1370, 1380, 1390, 1400, 1410, 1420, 1430, 1440, 1450, 1460, 1470, 1480, 1490, 1500, 1510, 1520, 1530, 1540, 1550, 1560, 1570, 1580, 1590, 1600, 1610, 1620, 1630, 1640, 1650, 1660, 1670, 1680, 1690, 1700, 1710, 1720, 1730, 1740, 1750, 1760, 1770, 1780, 1790, 1800, 1810, 1820, 1830, 1840, 1850, 1860, 1870, 1880, 1890, 1900, 1910, 1920, 1930, 1940, 1950, 1960, 1970, 1980, 1990, 2000, 2010, 2020, 2030, 2040, 2050, 2060, 2070, 2080, 2090, 2100, 2110, 2120, 2130, 2140, 2150, 2160, 2170, 2180, 2190, 2200, 2210, 2220, 2230, 2240, 2250, 2260, 2270, 2280, 2290, 2300, 2310, 2320, 2330, 2340, 2350, 2360, 2370, 2380, 2390, 2400, 2410, 2420, 2430, 2440, 2450, 2460, 2470, 2480, 2490, 2500, 2510, 2520, 2530, 2540, 2550, 2560, 2570, 2580, 2590, 2600, 2610, 2620, 2630, 2640, 2650, 2660, 2670, 2680, 2690, 2700, 2710, 2720, 2730, 2740, 2750, 2760, 2770, 2780, 2790, 2800, 2810, 2820, 2830, 2840, 2850, 2860, 2870, 2880, 2890, 2900, 2910, 2920, 2930, 2940, 2950, 2960, 2970, 2980, 2990, 3000, 3010, 3020, 3030, 3040, 3050, 3060, 3070, 3080, 3090, 3100, 3110, 3120, 3130, 3140, 3150, 3160, 3170, 3180, 3190, 3200, 3210, 3220, 3230, 3240, 3250, 3260, 3270, 3280, 3290, 3300, 3310, 3320, 3330, 3340, 3350, 3360, 3370, 3380, 3390, 3400, 3410, 3420, 3430, 3440, 3450, 3460, 3470, 3480, 3490, 3500, 3510, 3520, 3530, 3540, 3550, 3560, 3570, 3580, 3590, 3600, 3610, 3620, 3630, 3640, 3650, 3660, 3670, 3680, 3690, 3700, 3710, 3720, 3730, 3740, 3750, 3760, 3770, 3780, 3790, 3800, 3810, 3820, 3830, 3840, 3850, 3860, 3870, 3880, 3890, 3900, 3910, 3920, 3930, 3940, 3950, 3960, 3970, 3980, 3990, or 4000 g/acre.

For example, a formulation may be applied directly to the base of the plants or to the soil immediately adjacent to the plants. In some embodiments, a sufficient quantity of the formulation is applied such that it drains through the soil to the root area of the plants. Generally, application of a formulation may be performed using any method or apparatus known in the art, including but not limited to hand sprayer, mechanical sprinkler, or irrigation, including drip irrigation.

A formulation as provided herein may be applied to soil after planting. Alternatively, a formulation as provided herein may be applied to soil during planting, or may be applied to soil before planting. For example, a formulation as provided herein may be tilled into the soil or applied in furrow. In crops of water, such as rice, solid granulates comprising the compounds described herein may be applied to the flooded field or locus of the crop plants to be treated.

Also provided herein is a method of administering to a seed a compound (e.g., a compound of Formula I), optionally in a formulation as described herein. As used herein, the term “seed” broadly encompasses plant propagating material such as, tubers, cuttings, seedlings, seeds, and germinated or soaked seeds. For example, a compound as described herein may be applied to seeds or tubers by impregnating them with a liquid seed treatment formulation comprising a compound described herein, or by coating them with a solid or liquid formulation comprising a compound described herein.

Seed treatment methods described herein can be used in connection with any species of plant and/or the seeds thereof as described herein. Typically, the methods are used in connection with seeds of plant species that are agronomically important. In particular, the seeds can be of corn, peanut, canola/rapeseed, soybean, cucurbits, crucifers, cotton, beets, rice, Sorghum, sugar beet, wheat, barley, rye, sunflower, tomato, sugarcane, tobacco, oats, as well as other vegetable and leaf crops. For example, the seed can be corn, soybean, or cotton seed. The seed may be a transgenic seed from which a transgenic plant can grow and incorporate a transgenic event that confers, for example, tolerance to a particular herbicide or combination of herbicides, insect resistance, increased disease resistance, enhanced tolerance to stress and/or enhanced yield. Transgenic seeds include, but are not limited to, seeds of corn, soybean and cotton.

A seed treatment method may comprise applying the seed treatment formulation to the seed prior to sowing the seed, so that the sowing operation is simplified. In this manner, seeds can be treated, for example, at a central location and then dispersed for planting. This permits the person who plants the seeds to avoid the complexity and effort associated with handling and applying the formulations, and to merely handle and plant the treated seeds in a manner that is conventional for regular untreated seeds.

A formulation can be applied to seeds by any standard seed treatment methodology, including but not limited to mixing in a container (e.g., a bottle or bag), mechanical application, tumbling, spraying, immersion, and solid matrix priming. Seed coating methods and apparatus for their application are disclosed in, for example, U.S. Pat. Nos. 5,918,413; 5,891,246; 5,554,445; 5,389,399; 5,107,787; 5,080,925; 4,759,945 and 4,465,017, among others. Any conventional active or inert material can be used for contacting seeds with the formulation, such as conventional film-coating materials including but not limited to water-based film coating materials.

Also provided herein is a seed that has been treated with a formulation as described herein comprising a compound (e.g., a compound of Formula I) as described herein. The seed may have been treated with the formulation using one of the seed treatment methods set forth above, including but not limited to solid matrix priming, imbibition, coating, and spraying. The treated seed may be of any plant species, as described above.

A seed can be treated with a formulation as described herein, including formulating, mixing in a seed treatment tank, or combining on a seed by overcoating one or more additional active ingredients. The additional active ingredient may be, for example, an additional pesticide.

The pesticide may be, for example, an insecticide, a fungicide, an herbicide, or an additional nematicide as described herein.

The amount of a compound present on a treated seed sufficient to protect the seed, and/or the roots of a plant grown from the seed, against damage by phytopathogenicfungi can be readily determined by one of ordinary skill in the art. In some embodiments, the treated seed comprises a compound of Formula I in an amount of at least about 0.005 mg/seed. For example, treated seeds can comprise a compound of Formula I in an amount of from about 0.005 to about 2 mg/seed, from about 0.005 to about 1 mg/seed, or from about 0.05 to about 0.5 mg/seed.

### V. Enhancement of Plant Properties

In some embodiments, the contacting is sufficient to increase the biomass of the plant, relative to the biomass of a comparable plant grown for a comparable amount of time and not contacted with the compound. In some embodiments, the biomass of the plant is increased by at least about 5%, about 10%, about 15%, about 20%, about 25%, about 30%, about 35%, about 40%, about 45%, or about 50% as compared to an uncontacted plant. In some embodiments, the biomass is measured as dry-weight biomass.

In some embodiments, the yield (e.g., grain harvest yield) of the plant is increased as compared to an uncontacted plant. In some embodiments, the yield (e.g., grain harvest yield) of the plant is increased by at least about 5%, about 10%, about 15%, about 20%, about 25%, about 30%, about 35%, about 40%, about 45%, or about 50% as compared to an uncontacted plant.

In some embodiments, the plant exhibits altered levels of non-photochemical quenching (NPQ) as compared to an uncontacted plant. In some embodiments, for example, contacting the plant with the compound of Formula results in overall NPQ levels that are reduced by at least about 5%, at least about 10%, at least about 15%, at least about 20%, at least about 25%, at least about 30%, at least about 35%, at least about 40%, at least about 45%, or at least about 50%, as compared to NPQ levels in an uncontacted plant. In some embodiments, contacting the plant with the compound of Formula I alters the rate of NPQ in the contacted plant. For example, the treatment may reduce the rate of singlet chlorophyll relaxation to ground state chlorophyll. In some embodiments, a particular component of NPQ may be altered. For example, treatment of plants according to the methods provided herein may reduce or otherwise alter pH-regulated energy dissipation in the photosystem II antenna, termed the “qE” component of NPQ, or zeaxanthin-dependent quenching, termed the “qZ” component of NPQ.

NPQ can be measured by assessing chlorophyll fluorescence, e.g., using pulse-amplitude-modulation (PAM) fluorimetry as described by Ruban (Plant Physiol. 170, 2016, 1903-1916), Zaks et al. (Photosynth Res (2013) 116:389-409), and references cited therein. In some embodiments, NPQ levels in a plant are assessed by recording the maximum chlorophyll fluorescence in the dark (Fₘ) and light (Fₘ′). In certain instance Fₘ′ may be measured by illuminating the plant with actinic light (photo flux=8000-1200 μmol m⁻² s⁻¹) and applying one or more saturating pulses (photon flux=7,500-12,000 μmol m⁻² s⁻¹). NPQ can be calculated as NPQ=Fₘ−Fₘ′/Fₘ′. Reductions or other alterations to NPQ levels following treatment with furanone compounds according to the present disclosure can be quantified by comparing such fluorescence measurements in treated and untreated plants.

In some embodiments, the plant exhibits higher levels of carbon fixation as compared to an uncontacted plant. In some embodiments, carbon fixation levels of the plant are at least about 5% higher, at least about 10% higher, at least about 15% higher, at least about 20% higher, at least about 25% higher, at least about 30% higher, at least about 35% higher, at least about 40% higher, at least about 45% higher, or at least about 50% higher as compared to an uncontacted plant. Carbon fixation can be assessed using carbon dioxide gas exchange measurements as described, for example, by Stinziano et al. (Plant, Cell and Environment (2017) 40, 1256-1262). Such measurements may be made with an LI-6800 Portable Photosynthesis System (LI-COR, Lincoln NE) and like instrumentation; see, e.g., WO 2012/166954 and U.S. Pat. Nos. 8,610,072 and 9,678,050). These instruments can also incorporate PAM fluorimetry for measurement of chlorophyll fluorescence.

In some embodiments, the plant exhibits higher levels of carbon storage as compared to an uncontacted plant. In some instances, increased carbon storage may manifest as increased mass in roots, shoots, and/or storage organs such as tubers and rhizomes. In some embodiments, the carbon storage levels of the plant are at least about 5% higher, at least about 10% higher, at least about 15% higher, at least about 20% higher, at least about 25% higher, at least about 30% higher, at least about 35% higher, at least about 40% higher, at least about 45% higher, or at least about 50% higher as compared to an uncontacted plant. Carbon storage may be assessed by measuring the dry weight of plants after cultivation with and without treatment with a furanone according to the present disclosure. Alternatively, carbon storage may be assessed by assaying starch levels using commercially available starch assay kits.

In some embodiments, the plant exhibits a higher level of quantum efficiency (Fᵥ/Fₘ) as compared to an uncontacted plant. In some embodiments, the quantum efficiency level of the plant is at least about 5% higher, about 10% higher, about 15% higher, about 20% higher, about 25% higher, about 30% higher, about 35% higher, about 40% higher, about 45% higher, or about 50% higher as compared to an uncontacted plant. Fᵥ may calculated as Fₘ-Fₒ, where Fₒ is the measured minimal fluorescence until dark or low-light conditions.

In some embodiments, the plant exhibits a higher level of stomatal conductance as compared to an uncontacted plant. In some embodiments, the stomatal conductance levels of the plant is at least about 5% higher, about 10% higher, about 15% higher, about 20% higher, about 25% higher, about 30% higher, about 35% higher, about 40% higher, about 45% higher, or about 50% higher as compared to an uncontacted plant. Stomatal conductance can be measured, for example, using a porometer. Stomatal conductance can be measured by means known in the art, such as steady-state porometers, dynamic porometers, or null balance porometers,

In some embodiments, the plant exhibits a lower de-epoxidation level as compared to an uncontacted plant. The de-epoxidation level may be expressed as the ratio (A+Z/V+A+Z), where V is the level of violaxanthin (containing two epoxide groups), A is the level of antheraxanthin (containing one epoxide group), and Z is the level of zeaxanthin (lacking epoxide groups). Plant lumens become acidic when photosynthesis is saturated, activating violaxanthin de-epoxidase (VDE) which converts violaxanthin to antheraxanthin and zeaxanthin. In some embodiments, the de-epoxidation level of the plant is at least about 5% lower, about 10% lower, about 15% lower, about 20% lower, about 25% lower, about 30% lower, about 35% lower, about 40% lower, about 45% lower, or about 50% lower as compared to an uncontacted plant.

### VI. Substituted Furanone Compounds

Also provided herein are compounds according to Formula I

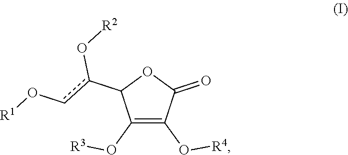

and salts and solvates thereof, wherein:
[symbol] is either a single or double bond;
R¹, R², R³, and R⁴ are independently selected from the group consisting of H, C₁₋₆ alkyl, 2- to 6-membered heteroalkyl, C₃₋₈ cycloalkyl, C₆₋₁₀ aryl, (C₆₋₁₀ aryl)-C₆₋₁₀ alkyl, 5- to 12-membered heteroaryl, (5- to 12-membered heteroaryl)-C₆₋₁₀ alkyl, 5- to 12-membered heterocyclyl, —C(O)R⁵, —C(O)₂R⁵, —C(O)N(R⁵)₂, —S(O)R⁵, and —S(O)₂R⁵;
R¹ and R² are optionally taken together with the oxygen atoms to which they are attached to form a ring which is optionally substituted with one or more R⁶ groups or R⁷ groups;
each R⁵ is independently selected from the group consisting of H, C₁₋₆ alkyl, 2- to 6-membered heteroalkyl, C₃₋₈ cycloalkyl, C₆₋₁₀ aryl, (C₆₋₁₀ aryl)-C₆₋₁₀ alkyl, 5- to 12-membered heteroaryl, (5- to 12-membered heteroaryl)-C₆₋₁₀ alkyl, and 5- to 12-membered heterocyclyl;
each R⁶ and R⁷ is independently selected from the group consisting of H, halo, amino, hydroxy, —OR⁵, —N(R⁵)₂, C₁₋₆ alkyl, 2- to 6-membered heteroalkyl, C₃₋₈ cycloalkyl, C₆₋₁₀ aryl, (C₆₋₁₀ aryl)-C₆₋₁₀ alkyl, 5- to 12-membered heteroaryl, (5- to 12-membered heteroaryl)-C₆₋₁₀ alkyl, and 5- to 12-membered heterocyclyl.

In some embodiments, R¹ and R² are taken together with the oxygen atoms to which they are attached to form the ring which is optionally substituted with one or more R⁶ groups or R⁷ groups. In some embodiments, R¹ and R² are taken together with the oxygen atoms to which they are attached to form a 1,3-dioxolane ring. In some embodiments, R¹ and R² are taken together with the oxygen atoms to which they are attached to form a 1,3-dioxolane ring and R⁶ and R⁷ are H. In some embodiments, R¹ and R² are taken together with the oxygen atoms to which they are attached to form a 1,3-dioxolane ring and R⁶ and R⁷ are C₁₋₆ alkyl. In some embodiments, R¹ and R² are taken together with the oxygen atoms to which they are attached to form a 1,3-dioxolane ring and R⁶ and R⁷ are methyl. In some embodiments, R¹ and R² are taken together with the oxygen atoms to which they are attached to form a 1,4-dioxane ring. In some embodiments, R¹ and R² are taken together with the oxygen atoms to which they are attached to form a 1,4-dioxane ring and R⁶ and R⁷ are H. In some embodiments, R¹ and R² are taken together with the oxygen atoms to which they are attached to form a 1,4-dioxane ring and R⁶ and R⁷ are C₁₋₆ alkyl. In some embodiments, R¹ and R² are taken together with the oxygen atoms to which they are attached to form a 1,4-dioxane ring and R⁶ and R⁷ are methyl.

In some embodiments, one or more of R¹, R², R³, and R⁴ are not H. In some embodiments, none of R¹, R², R³, and R⁴ are H. In some embodiments, one or more of R¹, R², R³, and R⁴ are C₁₋₆ alkyl. In some embodiments, each of R¹, R², R³, and R⁴ are C₁₋₆ alkyl. In some embodiments, one or more of R¹, R², R³, and R⁴ are methyl. In some embodiments, each of R¹, R², R³, and R⁴ are methyl. In some embodiments, [symbol] is a double bond. In some embodiments, [symbol] is a single bond.

In some embodiments, the compound is a compound according to Formula II:

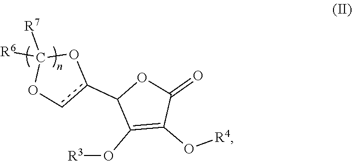

or a salt or solvate thereof,
wherein subscript n is 1, 2, 3, or 4.

In some embodiments, R³, R⁴, each R⁶, and each R⁷ are independently selected from the group consisting of H and C₁₋₆ alkyl. In some embodiments, R³, R⁴, each R⁶, and each R⁷ are independently C₁₋₆ alkyl. In some embodiments, R³, R⁴, each R⁶, and each R⁷ are independently selected from the group consisting of methyl, ethyl, n-propyl, iso-propyl, n-butyl, sec-butyl, iso-butyl, and tert-butyl. In some embodiments, R³, R⁴, each R⁶, and each R⁷ are methyl. In some embodiments, [symbol] is a double bond. In some embodiments, [symbol] is a single bond.

In some embodiments, the compound is a compound according to Formula III:

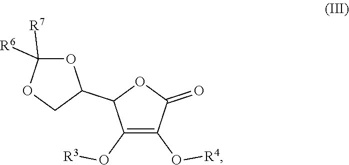

or a salt or solvate thereof.

In some embodiments, R³, R⁴, each R⁶, and each R⁷ are independently selected from the group consisting of H and C₁₋₆ alkyl. In some embodiments, R³, R⁴, each R⁶, and each R⁷ are independently C₁₋₆ alkyl. In some embodiments, R³, R⁴, each R⁶, and each R⁷ are independently selected from the group consisting of methyl, ethyl, n-propyl, iso-propyl, n-butyl, sec-butyl, iso-butyl, and tert-butyl. In some embodiments, R³, R⁴, each R⁶, and each R⁷ are methyl.

In some embodiments, the compound is a compound according to Formula IV:

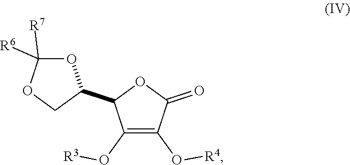

or a salt or solvate thereof.

In some embodiments, R³, R⁴, each R⁶, and each R⁷ are independently selected from the group consisting of H and C₁₋₆ alkyl. In some embodiments, R³, R⁴, each R⁶, and each R⁷ are independently C₁₋₆ alkyl. In some embodiments, R³, R⁴, each R⁶, and each R⁷ are independently selected from the group consisting of methyl, ethyl, n-propyl, iso-propyl, n-butyl, sec-butyl, iso-butyl, and tert-butyl. In some embodiments, R³, R⁴, each R⁶, and each R⁷ are methyl.

In some embodiments, the compound is a compound according to Formula V:

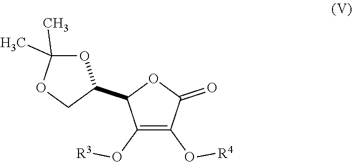

or a salt or solvate thereof,
wherein R³ and R⁴ are independently C₁₋₆ alkyl.

In some embodiments, the compound is a compound according to Formula VI:

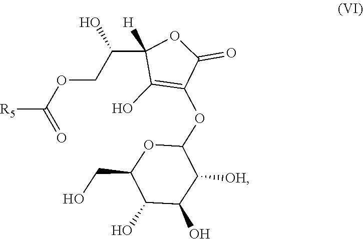

or a salt or solvate thereof.

In some embodiments, the compound is a compound according to a Formula selected from:

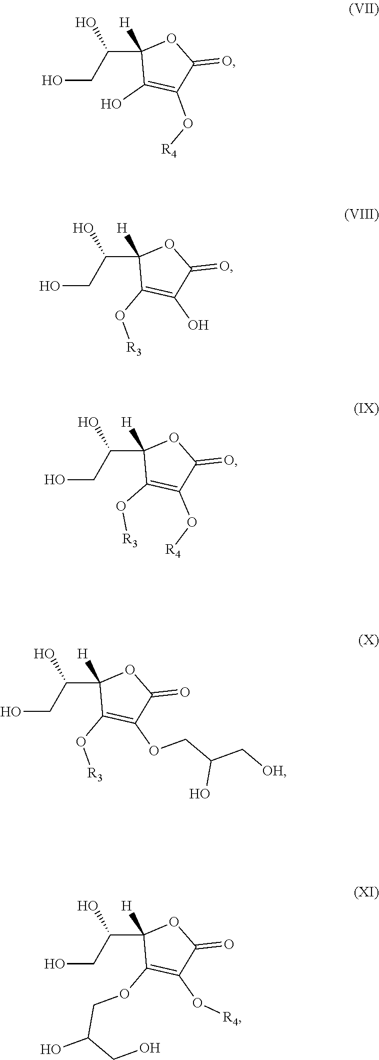

or a salt or solvate thereof.

In some embodiments, the compound is a compound according to a Formula selected from:

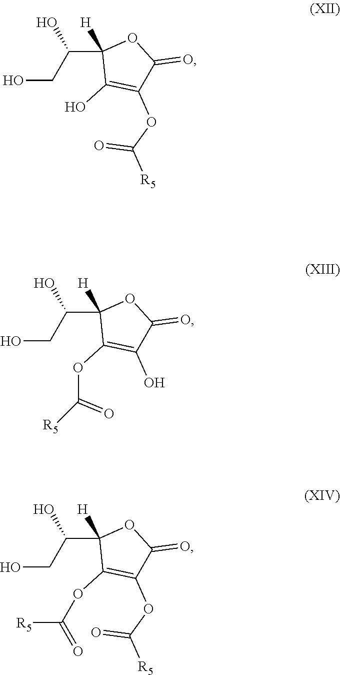

or a salt or solvate thereof.

In some embodiments, R³ and R⁴ are independently selected from the group consisting of H and C₁₋₆ alkyl. In some embodiments, R³ and R⁴ are independently C₁₋₆ alkyl. In some embodiments, R³ and R⁴ are independently selected from the group consisting of methyl, ethyl, n-propyl, iso-propyl, n-butyl, sec-butyl, iso-butyl, and tert-butyl. In some embodiments the compound is (5R)-5-(2,2-dimethyl-1,3-dioxolan-4-yl)-3,4-dimethoxyfuran-2(5H)-one (“Compound 1”).

In some embodiments, R¹, R², R³, and R⁴ are independently selected from the group consisting of H and C₁₋₆ alkyl. In some such embodiments, R¹, R², R³, and R⁴ are independently C₁₋₆ alkyl. In some embodiments, each of R¹, R², R³, and R⁴ are independently selected from the group consisting of methyl, ethyl, n-propyl, iso-propyl, n-butyl, sec-butyl, iso-butyl, and tert-butyl. In some embodiments, each of R¹, R², R³, and R⁴ are methyl.

In some embodiments, the compound of Formula I, II, III, IV, and/or V is not ascorbic acid.

Compounds according to Formula I, II, III, IV, V, VI, VII, VIII, IX, X, XI, XII, XIII, or XIV (including compounds according to any of the embodiments described above) may be formulated as formulations containing further components including, but not limited to, surfactants, dispersing agents, wetting agents, thickeners, stabilizers, chelators, penetration agents, adhesives, anticaking agents, emulsifying agents, defoamers, antifreeze, pigments, colorants, dyes, buffers, carriers, fertilizers, bacteria, viruses, fungi, plant growth regulators, insect growth regulators, microbial growth regulators, pesticides, antimicrobials, herbicides, and combinations thereof, as described above.

### VI. Examples

### Example 1. Synthesis of (5R)-5-(2,2-dimethyl-1,3-dioxolan-4-yl)-3,4-dimethoxyfuran-2(5H)-one (Compound 1)

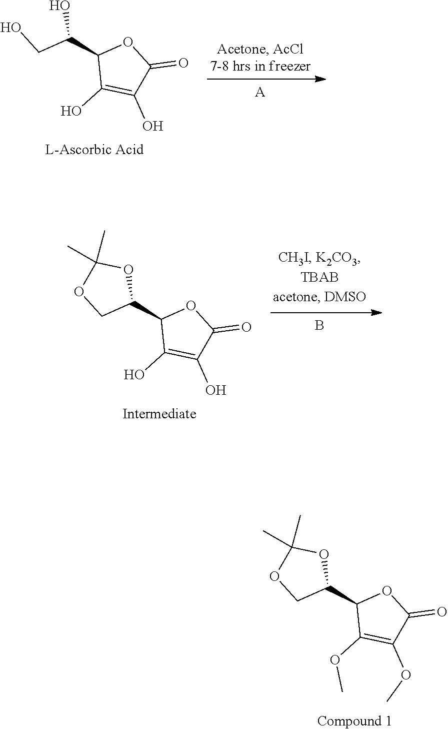 [SMILES: O=C1O[C@H]([C@@H](O)CO)C(O)=C1O ; CC1(C)OC[C@@H]([C@H]2OC(=O)C(O)=C2O)O1 ; COC1=C(OC)[C@@H]([C@@H]2COC(C)(C)O2)OC1=O]

Compound 1 and related compounds are synthesized according to the methods described in Wang et. al., Eur. J. Med. Chem. 2016, 110, 376-388, which is hereby incorporated by reference in its entirety for all purposes. Briefly, L-ascorbic acid is converted to 5,6-O-isopropylidene-L-ascorbic acid (Intermediate) by dissolving L-ascorbic acid (5 g, 28.4 mmol) in acetone (25 mL) containing a catalytic amount of acetyl chloride (0.557 g, 7.1 mmol) at 0° C. The reaction mixture was stirred at room temperature for 3 hours (monitored by TLC) and allowed to stand overnight. The solid was filtered, washed with cold acetone (10 mL) and dried under vacuum to get the Intermediate (4 g, 65%) as a white solid. LCMS: 215.2 (MH+), 431.2 (MH+, dimer); 1H-NMR (400 MHz, CDCl₃) δ 8.49 (s, 1H), 4.71 (d, J=2.80 Hz, 1H), 4.29-4.25 (m, 1H), 4.10 (t, J=7.20 Hz, 1H), 3.90-3.87 (m, 1H), 1.26 (s, 6H). 5,6-O-isopropylidene-L-ascorbic acid is methylated at the C-2 and C-3 hydroxy groups of the lactone ring. To a solution of 5,6-O-isopropylidene-L-ascorbic acid (2 g, 9.2 mmol), in a mixture of DMSO and acetone (20 mL, 1:4), were added potassium carbonate (3.84 g, 27.8 mmol), methyl iodide (6.66 g, 46.28 mmol) and TBAB (0.34 g, 0.92 mmol) at room temperature. The reaction mixture was stirred at room temperature for 24 hours (monitored by TLC). The reaction mixture was quenched with water (40 mL) and the product was extracted with ethyl acetate (100 mL*2). The combined extracted was washed with brine (30 mL), dried over anhydrous sodium sulphate, filtered and concentrated under reduced pressure. The crude was purified by column chromatography over silica gel using 30% ethyl acetate in hexane as eluent to get Compound 1 (1.2 g, 53%) as a white solid. LCMS: 245.1 (MH+); 1H-NMR (400 MHz, CDCl₃) δ 4.53 (d, J=2.80 Hz, 1H), 4.32-4.28 (m, 1H), 4.19 (s, 3H), 4.18-4.14 (m, 1H), 4.08-4.04 (m, 1H), 3.88 (s, 3H), 1.42 (s, 3H), 1.38 (s, 3H).

### Example 2. Synthesis of (R)-5-((S)-1,2-dihydroxyethyl)-3,4-dimethoxyfuran-2(5H)-one (Compound 2)

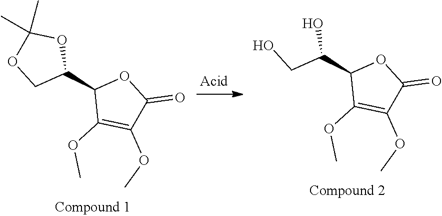 [SMILES: COC1=C(OC)[C@@H]([C@@H]2COC(C)(C)O2)OC1=O ; COC1=C(OC)[C@@H]([C@@H](O)CO)OC1=O]

Deprotect Compound 1 under acidic conditions to yield Compound 2 according to the methods described in M. R. Maddani, K. R. Prabhu, Synlett, 2011, 821-825 (e.g., using aqueous tert-butyl hydroperoxide (70%).

### Example 3. Compound 1 Increases Corn Yield in Treated Plants

Corn field trials were performed in Illinois and Iowa. In each trial, individual plots measured 10 feet by 30 feet and each treatment (application of Compound 1 or untreated control) was replicated across 4 plots in a randomized complete block design. Agronomic practices were maintained under standard commercial conditions and products used for weed, insect, and disease control. The Walnut, Illinois trial site was planted in mid-May and harvested in early October. The Richland, Iowa site was planted in late April and harvested in late September. Compound 1 was applied to both sites once in late June. Grain weight and grain moisture were measured for each plot at harvest, data is reported as bushels per acre normalized to 13% moisture content.

### Example 4. Compound 1 Increases CO₂ Assimilation and Quantum Efficiency in Treated Plants

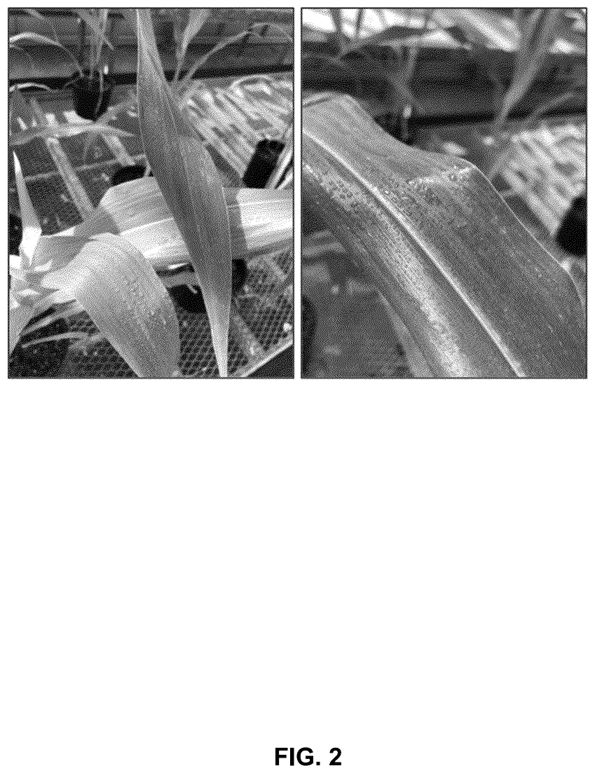

Greenhouse application of Compound 1: Corn plants were grown in a greenhouse for 9 weeks (V5) prior to treatment. Eight plants were treated with a mock solution (formulation blank), low rate (0.8 fl. oz) or medium rate (1.7 fl. oz). The low rate and medium rate refer to the volume of the Compound 1 containing solution that is applied to 1 acre of corn plants, and roughly equates to 5 grams of Compound 1 per acre for low rate and about 10 grams of Compound 1 per acre for medium rate. The foliar blends were prepared by mixing the formula concentrations into water followed by vigorous mixing. To mimic a foliar application in a corn field (using a spray boom), a uniform coating of the entire plant was carried out (FIG. 2) using a hand-held spray bottle. Following application, the plants were separated to avoid cross contamination (aerosol drift) and allowed to dry.

Measurement of carbon assimilation: Assessment of the effects of Compound 1 on photosynthesis in corn plants, tobacco plants, and soybean plants was performed using a LI-COR 6800 fluorimeter, which measured net carbon assimilation (Anet), transpiration (E) and stomatal conductance (gsw). The youngest fully expanded leaf with a fully formed ligule was used from each plant for sampling. A single sample (biological representative) consisted of averaging the readings from three technical representatives adjacent to each other on each sampled leaf. Each treatment consisted of eight biological representatives (N=8). Photobiology measurements were taken at 2 and 24 hour time points, post application.

Measurement of chlorophyll fluorescence: Chlorophyll fluorescence measurements were determined 4 hrs and 24 hrs after treatment using a LI-COR 6800 fluorimeter (LI-COR Biosciences; Lincoln, Nebraska). Corn plants were dark-adapted 60-90 min prior to measurement and the youngest fully expanded leaf with a fully formed ligule was used for the measurement. Minimal fluorescence levels in the dark (Fₒ) and light (Fₒ′) were recorded by applying a measuring light of 12 μmol photons m⁻² s⁻¹. Maximum fluorescence levels in the dark (Fₘ) and light (Fₘ′) were recorded by applying a saturating pulse of light at 10,000 μmol photons m⁻² s⁻¹. Maximum quantum efficiency of PSII in the dark (Fᵥ/Fₘ) and light (Fᵥ′/Fₘ′) were calculated as (Fₘ−Fₒ/Fₘ) using their respective dark or light-adapted values. NPQ induction was measured after a 5 minute exposure to an actinic light source at 1,000 μmol photons m⁻² s⁻¹ and calculated as (Fₘ−Fₘ′/Fₘ′).

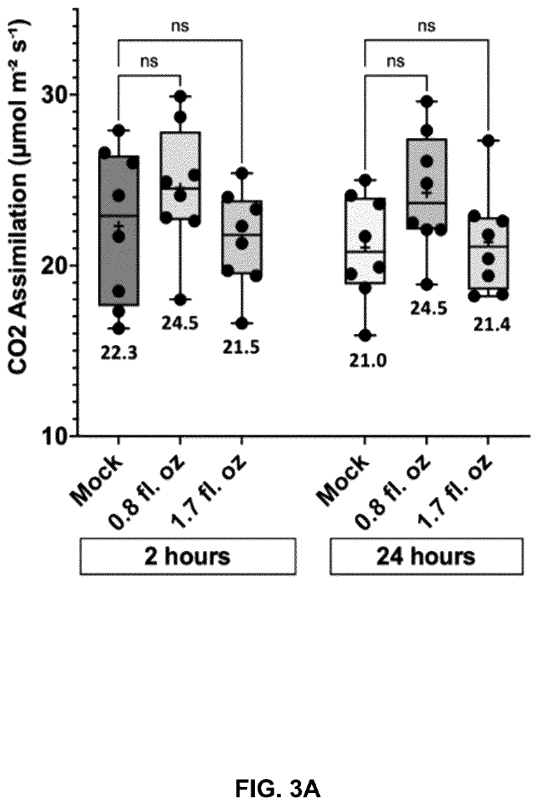

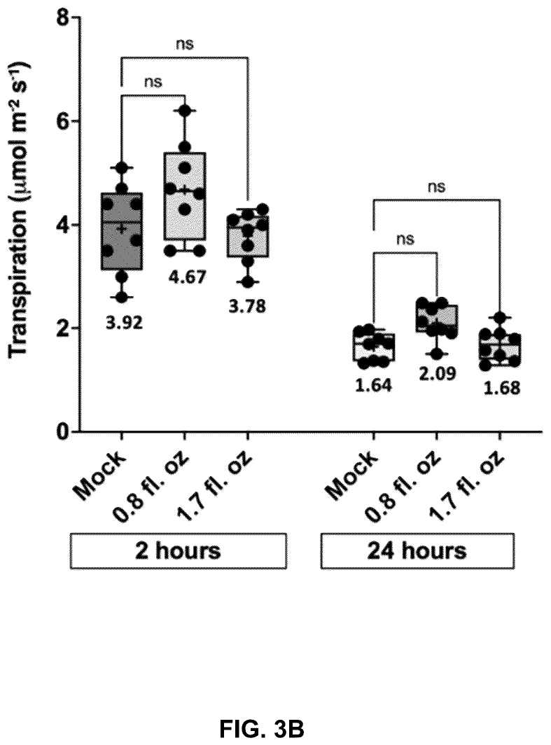

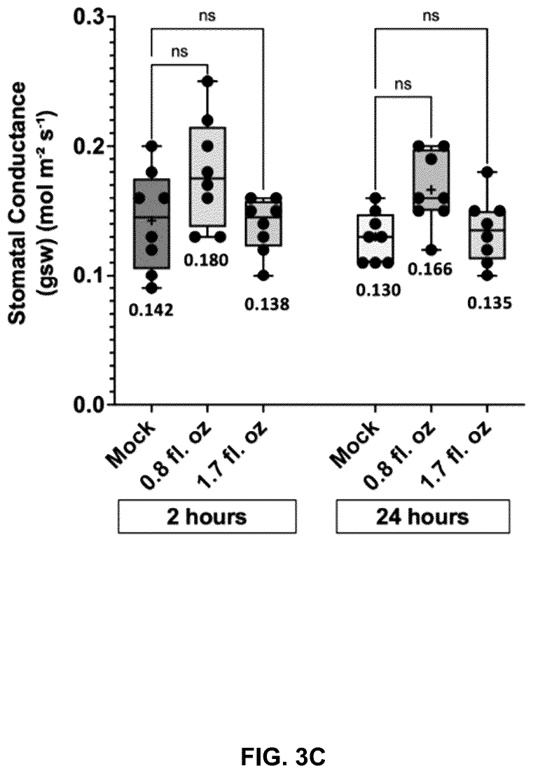

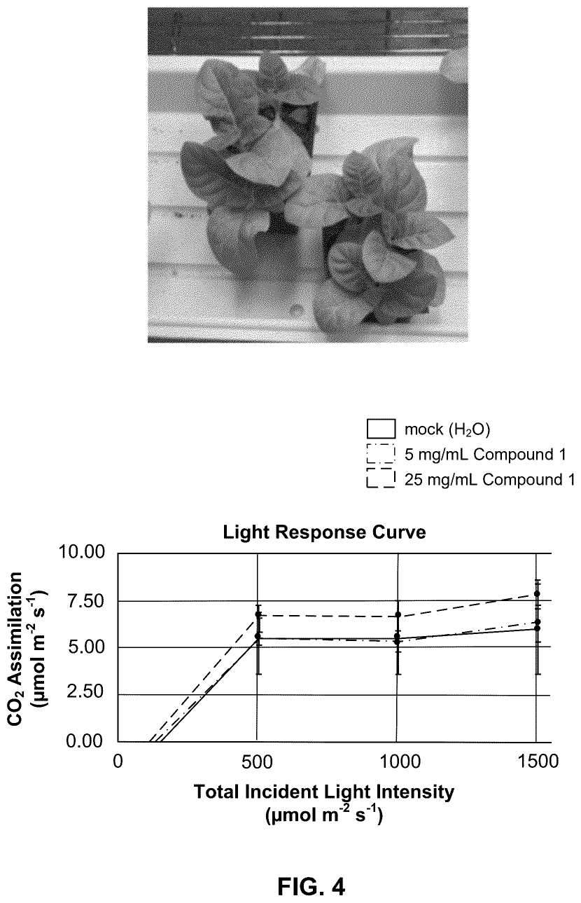

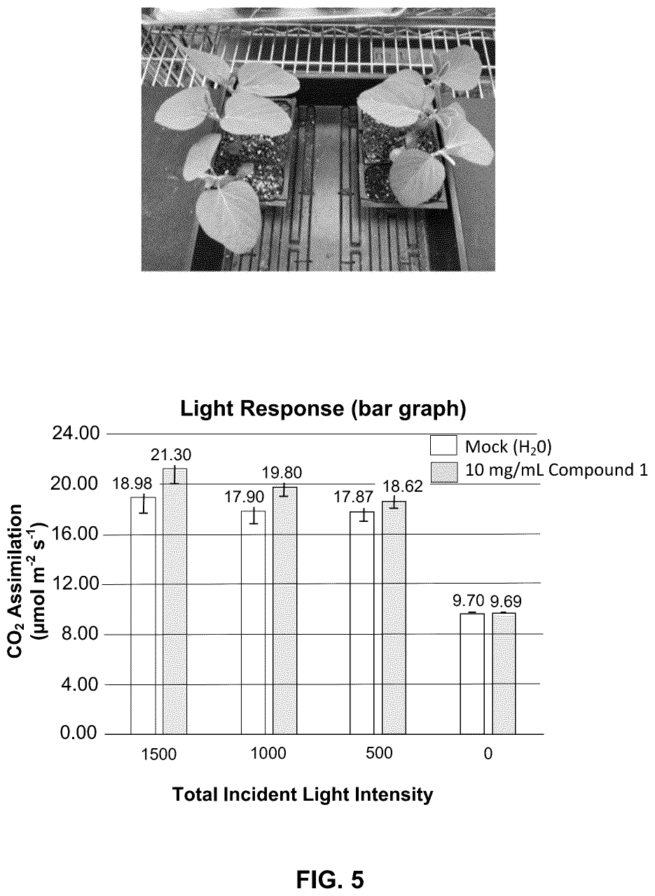

Results: All three photobiology metrics (CO₂ assimilation, transpiration and stomatal conductance) were elevated in corn plants at the 0.8 fl. oz rate compared to the mock at both time points (FIGS. 3A, 3B & 3C), suggesting Compound 1 may be acting to increase these aspects of photosynthesis. The three photobiology metrics for the 1.7 fl. oz rate were similar to the mock control for both the 2 hour time point and the 24 hour time point. All treatment values for the 24 hour time point were low compared to the 2 hour point, suggesting the background formulation mixture (without Compound 1) may have a slight inhibitory effect upon initial treatment (<3 days post application) requiring time for the plants to adapt to the treatment. Similar CO₂ assimilation effects were observed in tobacco plants (FIG. 4) and soybean plants (FIG. 5) compared to mock treatment.

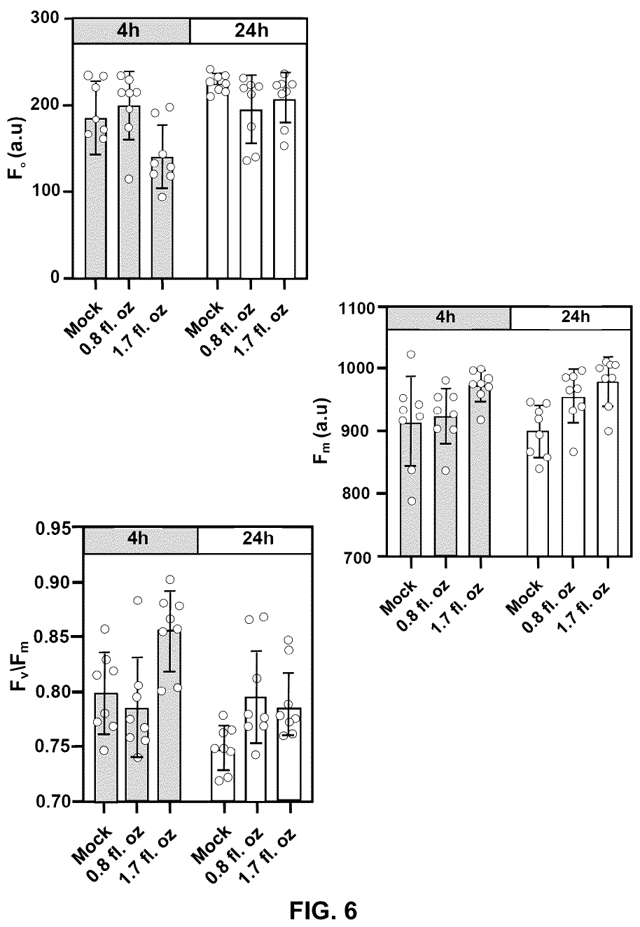

After a dark-adaptation and 4 hrs post foliar application, the Fₒ of the high rate of Compound 1 was lower in comparison to the low rate and mock control (FIG. 6). While the Fₒ of all treatment groups increased after 24 hrs, both the low and high rates of Compound 1 were lower compared to the mock control. Conversely, the maximum fluorescence was higher in the Compound 1 treated plants after 24 hrs with the low rate and at both timepoints with the high rate. Data suggests that, the dark-adapted quantum efficiency of PSII was higher in the Compound 1 treated plants after 4 hrs for the high rate, and after 24 hrs for both rates.

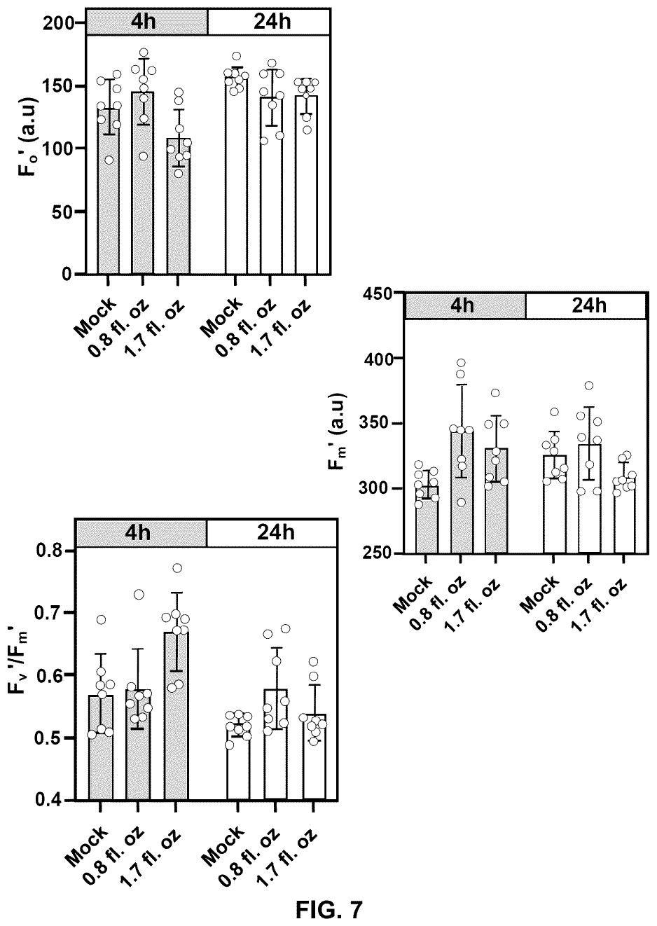

The light-adapted Fₒ′ displayed a similar trend as the dark Fₒ for both rates (FIG. 7). In addition, the light-adapted Fₘ′ was similarly higher for the two rates 4 hrs post application. However, unlike the dark-adapted Fₘ, the light-adapted Fₘ′ was not higher after 24 hrs post application. Therefore, only the high rate displayed a higher light-adapted quantum efficiency of PSII in comparison to the mock 4 hrs post application. At 24 hrs post application, only the low rate displayed a higher light-adapted quantum efficiency of PSII in comparison to the mock.

### Example 5. Manufacturing of Compound 1 Dispersion Concentrate (DC) Formulation

The raw materials used in this formulation are summarized in Table 1.

TABLE 1
Compound 1 Formulation

| Material | % WT |
|---|---|
| Compound 1 (99% pure) | 13.31 |
| Agnique ® AMD 3L (N,N-dimethyl lactamide) | 86.69 |

During the formulation and milling process of the dispersion concentrate the temperature was maintained below 50° C. To begin the manufacturing process, the batch quantity of Agnique® AMD 3L was charged to an appropriate size vessel fitted with suitable agitation. The batch quantity of Compound 1 was charged and stirred until the Compound 1 was fully dissolved. The agitation speed was adjusted to avoid air entrainment. Analysis was then submitted for analysis. Once the batch passed the release specification, the product was filtered (100 mesh filter) and packed-off into appropriate containers.

### Example 6. Manufacturing of Compound 1 Oil Dispersion (OD) Formulation

The raw materials used in this formulation are summarized in Table 2.

TABLE 2
Compound 1 Formulation

| Material | % WT |
|---|---|
| Compound 1 (99% pure) | 20.14 |
| Cirrasol ™ G-1086 (Polyoxyethylene (40) | 19.74 |
| sorbitol hexaoleate) | |
| Atlox ™ 4914 (CAS No. 173717-47-0) | 4.94 |
| Attagel ® 50 (CAS No. 12174-11-7) | 0.49 |
| BHT | 0.20 |
| Sunflower oil | 54.49 |

A mixing vessel of suitable capacity and adequate agitation was used. A colloid mill for pre-grinding particles was used as well as a bead mill (Dyno® Mill, China). During the formulation and milling process of the dispersion concentrate the temperature was maintained below 50° C. To reduce viscosity, Cirrasol™ G-1086 may be heated to 45-50° C.

The batch quantity of sunflower oil was charged to an appropriate size vessel fitted with suitable agitation. The batch quantity of Cirrasol™ G-1086 was charged to the sunflower oil and stirred until the Cirrasol™ G-1086 was fully dispersed. Agitation speed was adjusted to avoid air entrainment. Next, the batch quantity of Atlox™ 4914, Attgel® 50 and BHT was charged to the sunflower oil/Cirrasol™ G1086 solution and stirred until the materials were fully dispersed. Stirrer speed was adjusted to avoid air entrainment. Next, the batch quantity of Compound 1 was charged to the sunflower oil/surfactant solution and stirred until Compound 1 was fully dispersed. Stirrer speed was adjusted to avoid air entrainment.

The Compound 1 slurry was then passed through an in-line colloid mill to fully disperse the Compound 1 formulation and to reduce the particle size of the Compound 1 formulation such that the slurry is suitable to bead mill. The number of passes through the colloid mill may depend upon the particle size of the Compound 1 formulation and the type of colloid mill used. Particle size of the slurry is determined by a wet sieve test and should be <0.1% w/w retained on a 150 μm sieve.

The Compound 1 formulation particle size may be reduced using a bead mill. Typical milling conditions are summarized in Table 3.

TABLE 3
Typical Milling Conditions

| Bead charge | 80% | |
|---|---|---|
| Bead type | Unleaded glass or Ceramic | |
| Bead size | 1.0-1.3 | mm |
| Agitator tip speed | 10 | m/s |

While the exact milling conditions may depend on mill type, the required particle size of the milled slurry are a primary particle size D50<4 μm D90<10 μm. The wet sieve test may be <0.2% retained on a 150 μm sieve, <0.1% retained on a 45 μm sieve. Sample may be submitted for analysis and once the batch passes the release specification, the product may be filtered (100 mesh filter) and packed off into appropriate containers.

### Example 7. Efficacy of Compound 1 on the Yield and Quality of Corn

Corn field trials were performed in Illinois, Missouri, Ohio, Arkansas, Tennessee, and Mississippi using a randomized complete block design with six replications in locations were the land was relatively flat and had uniform soil moisture and soil texture. The trials were planted in areas of commercial corn production and in which irrigation could be utilized if rainfall was inadequate to sustain the studies, and fertility was maintained at local recommendations.

Production Practices: Commercial corn varieties were grown in in each location and were adapted and available to each region. The seed was sown at a rate consistent with local practices. Base levels of fertility for all nutrients followed local recommendations. Unless otherwise stated, standard commercial practices were maintained in terms of production practices and products used for weed, insect, and disease control. Any maintenance herbicides or pesticides were not applied within three days of the treatment applications.

Treatment Application: All treatments were applied in a spray volume of approximately 15 gallons per acre as a foliar application as described in the treatment list (Table 4). All treatments were applied with a non-ionic surfactant (0.125% v/v). All treatment mixes were shaken before adding to the application tank and the tank mix was thoroughly agitated prior to application.

TABLE 4
Treatment List

| | | Rate | Rate | Application |
|---|---|---|---|---|
| Treatment | Treatment | (fl oz/acre) | (grams/acre) | timing |
| 1 | Non-treated | n/a | n/a | — |
| | Control | | | |
| 4 | Compound 1 | 0.7 | ~4 | V4 |
| | (Oil Dispersion) | | | |
| 5 | Compound 1 | 1.0 | ~4 | V4 |
| | (Dispersible | | | |
| | Concentrate) | | | |

### Example 8. Cool Grow Procedure One

Corn (Syngenta Agrisure Artesian, Basel, Switzerland) seeds (n=2) were planted in 24 one liter pots containing Sunshine soil #1 (Sun Gro, Agawam, MA) mixed with ⅛ tbsp of Osmocote Plus 15-9-12 NPK (Bloomington Brands LLC, Bloomington, IN) slow release fertilizer. Pots were placed on plant holder trays (11×22 in) with three pots per tray and were set-up in a 4×4 ft Cool Grow tent (capacity: 35 one liter pots) with temperature set at 24° C. and light at 250 umoL for 12 h day and night.

Upon emergence, one seedling was culled leaving only one plant per pot. Plants were fertilized once two times a week with Miracle-Gro® 24-8-16 (Miracle-Gro Company, Marysville, OH) starting one week after germination. Plants of similar size were selected for foliar treatment application, discarding three plants in the process. At V2-3 stage (16 days after seeding), each plant was sprayed with 7.5 mL of the following formulations: water (7 plants total); OD formulation (7 plants total; 8.25 μL of OD formulation from Example 6 dissolved in 50 mL of water); DC formulation (7 plants total; 12.4 μL of DC formulation from Example 5 dissolved in 50 mL of water). One week after spray treatment, photosynthetic measurements were made using Licor (LI-COR Biotechnology, Lincoln, NE), see Table 5 for conditions. Digital biomass and Normalized Difference Vegetation Index (NDVI; an indicator of photosynthetically active biomass) were measured by a PlantEye F600Multispectral 3D scanner (Phenospex, Netherlands) at V4-5 stage and plants were harvested after measurements.

TABLE 5
Licor Conditions

| Actinic Light | 1000 | μE |
|---|---|---|
| Saturating Pulse | 10000 | μE |
| Dark Acclimation | 45 | min |
| Relative Humidity | 60% | |
| CO₂ | 400 | ppm |

| | |
|---|---|
| Light Measurements | Carbon assimilation, Stromatal conductance |
| Dark Measurements | Fluorescence |

### Results

The mean photosynthetic assimilation (A) were 27.66 μmol m⁻² s⁻¹, 27.35 μmol m⁻² s⁻¹ and 28.44 μmol m⁻² s⁻¹ for water, DC formulation and OD formulation respectively (FIG. 8). While the OD formulation exhibited a higher assimilation it was not statistically significant. Mean digital biomass was higher for Compound 1 treated plants, with mean values of 20082014 mm³, 21089986 mm³ and 21983186 mm³ for water, DC formulation and OD formulation respectively (FIG. 9), however, they were not statistically significant. Similarly, mean shoot dry weights were higher for DC formulation (4.60 g) and OD formulation (4.40 g) compared to water (3.88 g) but not statistically significantly (FIG. 10).

### Example 9. Coll Grow Procedure Two

Corn (Syngenta Agrisure Artesian, Basel, Switzerland) seeds (n=2) were planted in 24 four inch pots containing Sunshine soil #1 (Sun Gro, Agawam, MA) mixed with ⅛ tbsp of 14-14-14 osmocote N—P—K (Bloomington Brands LLC, Bloomington, IN) slow-release fertilizer and Micromax (ICL Specialty Fertilizers) (lg/L). Pots were placed on plant holder trays (11×22 in) with three pots per tray and were set-up in a 4×4 ft Cool Grow tent (capacity: 35 one liter pots) with temperature set at 24° C. and light at 345 μmoL for 12 hours day and night. Upon emergence, one seedling was culled leaving only one plant per pot. Plants were fertilized weekly thereafter starting one week after germination with 20-20-20 NPK (1 tsp/gallon) (Bloomington Brands LLC, Bloomington, IN) applied at ˜800-1000 mL per tray.

At V2-3 stage (14 days after seeding), each plant was sprayed with 7.5 mL of the following formulations: formulation blank DC (12 plants total; Agnique® AMD 3L (N,N-dimethyl lactamide)); Compound 1 DC formulation (9.86 μL of DC formulation from Example 5 dissolved in 50 mL of water). After 90 minutes following spray treatment, photosynthetic measurements were made using Licor. Digital biomass and NDVI measurements were made 21 days after seeding by a PlantEye F600Multispectral 3D scanner (Phenospex, Netherlands) and plants were harvested at 27 days after seeding.

TABLE 6
Licor Conditions

| Actinic Light | 1000 | μE |
|---|---|---|
| Saturating Pulse | 10000 | μE |
| Dark Acclimation | 45 | min |
| Relative Humidity | 60% | |
| CO₂ | 400 | ppm |

| | |
|---|---|
| Light Measurements | Carbon assimilation, Stromatal conductance |
| Dark Measurements | Fluorescence |

### Results

The mean photosynthetic assimilation (A) were 12.52 μmol m⁻² s⁻¹ and 13.79 μmol m⁻² s⁻¹ for Formulation Blank DC and Formulated Compound 1 DC respectively (FIG. 11). While the DC formulation exhibited a higher assimilation it was not statistically significant. Mean digital biomass values were 12984500 mm³ and 12926773 mm³ for Formulation Blank DC and Formulated Compound 1 DC respectively (FIG. 12), but the results were not statistically significant. A statistically significant difference (p<0.05) was observed for the NDVI for Compound 1 treated plants (0.569) compared to formulation blank DC treated (0.558) (FIG. 13). Similarly, mean shoot dry weight were statistically significantly higher (p<0.1) for Compound 1 treated plants (3.62 g) compared to formulation blank DC treated plants (3.16 g) (FIG. 14).

### VIII. Embodiments

Embodiment 1: A method for cultivating a plant, the method comprising contacting the plant with an effective amount of a compound according to Formula I:

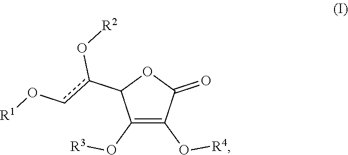

or a salt or solvate thereof, wherein:
[symbol] is either a single or double bond;
R¹ and R² are independently selected from the group consisting of H, C₁₋₆ alkyl, C₁₋₆ alkyl-diol, 2- to 6-membered heteroalkyl, C₃₋₈ cycloalkyl, C₆₋₁₀ aryl, (C₆₋₁₀ aryl)-C₆₋₁₀ alkyl, 5- to 12-membered heteroaryl, (5- to 12-membered heteroaryl)-C₆₋₁₀ alkyl, 5- to 12-membered heterocyclyl, —C(O)R⁵, —C(O)₂R⁵, —C(O)N(R⁵)₂, —S(O)R⁵, and —S(O)₂R⁵;
R¹ and R² are optionally taken together with the oxygen atoms to which they are attached to form a ring which is optionally substituted with one or more R⁶ groups or R⁷ groups;
R³ and R⁴ are independently selected from the group consisting of phosphate, hydrogen phosphate, monohydrogen phosphate, and dihydrogen phosphate, H, C₁₋₆ alkyl, C₁₋₆ alkyl-diol, 2- to 6-membered heteroalkyl, C₃₋₈ cycloalkyl, C₆₋₁₀ aryl, (C₆₋₁₀ aryl)-C₆₋₁₀ alkyl, 5- to 12-membered heteroaryl, (5- to 12-membered heteroaryl)-C₆₋₁₀ alkyl, 5- to 12-membered heterocyclyl, —C(O)R⁵, —C(O)₂R⁵, —C(O)N(R⁵)₂, —S(O)R⁵, and —S(O)₂R⁵;
each R⁵ is independently selected from the group consisting of H, C₁₋₆ alkyl, 2- to 6-membered heteroalkyl, C₃₋₈ cycloalkyl, C₆₋₁₀ aryl, hydroxy-(C₆₋₁₀ aryl), (C₆₋₁₀ aryl)-C₆₋₁₀ alkyl, 5- to 12-membered heteroaryl, (5- to 12-membered heteroaryl)-C₆₋₁₀ alkyl, 5- to 12-membered heterocyclyl, and 5- to 12-membered substituted heterocyclyl; and
each R⁶ and R⁷ is independently selected from the group consisting of H, halo, amino, hydroxy, —OR⁵, —N(R⁵)₂, C₁₋₆ alkyl, 2- to 6-membered heteroalkyl, C₃₋₈ cycloalkyl, C₆₋₁₀ aryl, (C₆₋₁₀ aryl)-C₆₋₁₀ alkyl, 5- to 12-membered heteroaryl, (5- to 12-membered heteroaryl)-C₆₋₁₀ alkyl, and 5- to 12-membered heterocyclyl.

Embodiment 2: The method of Embodiment 1, wherein R¹ and R² are taken together with the oxygen atoms to which they are attached to form the ring which is optionally substituted with one or more R⁶ groups or R⁷ groups.

Embodiment 3: The method of Embodiment 1 or Embodiment 2, wherein the compound is a compound according to Formula II:

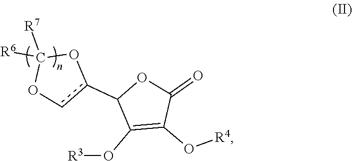

or a salt or solvate thereof,
wherein subscript n is 1, 2, 3, or 4.

Embodiment 4: The method of any one of Embodiments 1-3, or a salt or solvate thereof, wherein [symbol] is a double bond.

Embodiment 5: The method of any one of Embodiments 1-3, or a salt or solvate thereof, wherein [symbol] is a single bond.

Embodiment 6: The method of Embodiment 5, wherein the compound is a compound according to Formula III:

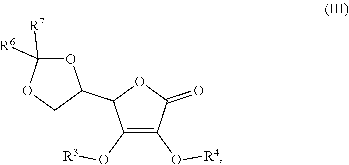

or a salt or solvate thereof.

Embodiment 7: The method or Embodiment 6, wherein the compound is a compound according to Formula IV:

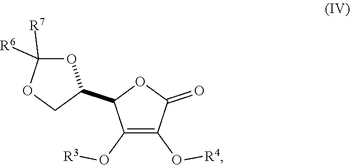

or a salt or solvate thereof.

Embodiment 8: The method of any one of Embodiments 1-7, wherein R³, R⁴, each R⁶, and each R⁷ are independently selected from the group consisting of H and C₁₋₆ alkyl.

Embodiment 9: The method of Embodiment 8, wherein R³, R⁴, each R⁶, and each R⁷ are independently C₁₋₆ alkyl.

Embodiment 10: The method of Embodiment 9, wherein each of R³, R⁴, each R⁶, and each R⁷ are independently selected from the group consisting of methyl, ethyl, n-propyl, iso-propyl, n-butyl, sec-butyl, iso-butyl, and tert-butyl.

Embodiment 11: The method of Embodiment 9, wherein each of R³, R⁴, each R⁶, and each R⁷ are methyl.

Embodiment 12: The method of any one of Embodiments 1-7, wherein the compound is a compound according to Formula V:

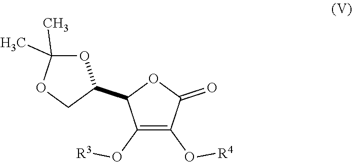

or a salt or solvate thereof,
wherein R³ and R⁴ are independently C₁₋₆ alkyl.

Embodiment 13: The method of Embodiment 1, wherein R¹, R², R³, and R⁴ are independently selected from the group consisting of H and C₁₋₆ alkyl.

Embodiment 14: The method of Embodiment 1 or Embodiment 13, wherein R¹, R², R³, and R⁴ are independently C₁₋₆ alkyl.

Embodiment 15: The method of Embodiment 14, wherein each of R¹, R², R³, and R⁴ are independently selected from the group consisting of methyl, ethyl, n-propyl, iso-propyl, n-butyl, sec-butyl, iso-butyl, and tert-butyl.

Embodiment 16: The method of Embodiment 15, or a salt or solvate thereof, wherein each of R¹, R², R³, and R⁴ are methyl.

Embodiment 17: The method of any one of Embodiments 1-16, wherein the plant is selected from the group consisting of cotton, alfalfa, Arabidopsis, banana, barley, canola, castor bean, chrysanthemum, clover, cocoa, coffee, cottonseed, corn (maize), crambe, cranberry, cucumber, dendrobium, dioscorea, eucalyptus, fescue, flax, gladiolus, liliacea, linseed, millet, muskmelon, mustard, oat, oil palm, oilseed rape, papaya, peanut, pineapple, ornamental plants, Phaseolus, potato, rapeseed, rice, rye, ryegrass, safflower, sesame, sorghum, soybean, sugarbeet, sugarcane, sunflower, strawberry, tobacco, tomato, turfgrass, wheat and vegetable crops such as lettuce, celery, broccoli, cauliflower, cucurbits, onions (including garlic, shallots, leeks, and chives); fruit and nut trees, such as apple, pear, peach, orange, grapefruit, lemon, lime, almond, pecan, walnut, hazel; vines, such as grapes, kiwi, hops; fruit shrubs and brambles, such as raspberry, blackberry, gooseberry; forest trees, such as ash, pine, fir, maple, oak, chestnut, poplar; with alfalfa, canola, castor bean, corn, cotton, crambe, flax, linseed, mustard, oil palm, oilseed rape, peanut, potato, rice, safflower, sesame, soybean, sugarbeet, sugarcane, sunflower, tomato and wheat.

Embodiment 18: The method of Embodiment 17, wherein the plant is corn or soybean.

Embodiment 19: The method of any one of Embodiments 1-18, wherein contacting the plant with the compound according to Formula I comprises contacting the plant with an agricultural formulation comprising the compound of Formula I, or a salt or solvate thereof, and an agriculturally acceptable carrier.

Embodiment 20: The method of Embodiment 19, wherein the carrier comprises water.

Embodiment 21: The method of Embodiment 19 or Embodiment 20, wherein the agricultural formulation further comprises a surfactant, a dispersing agent, a wetting agent, a thickener, a stabilizer, a chelator, or combinations thereof.

Embodiment 22: The method of any one of Embodiments 19-21, wherein the agricultural formulation further comprises a pesticide.

Embodiment 23: The method of any one of Embodiments 19-22, wherein the agricultural formulation further comprises a bacterium, a virus, a fungus, or a combination thereof.

Embodiment 24: The method of any one of Embodiments 19-23, wherein the agricultural formulation further comprises a plant growth regulator, an insect growth regulator, a microbial growth regulator, or a combination thereof.

Embodiment 25: The method of any one of Embodiments 1-24 wherein the contacting comprises contacting a leaf of the plant, a stem of the plant, a root of the plant, or combinations thereof.

Embodiment 26: The method of any one of Embodiments 1-25, wherein the formulation is applied as a foliar spray.

Embodiment 27: The method of Embodiment 26, wherein the formulation is applied as an aqueous solution.

Embodiment 28: The method of any one of Embodiments 1-27, wherein the contacting is sufficient to increase the biomass of the plant, relative to the biomass of a comparable plant grown for a comparable amount of time and not contacted with the compound.

Embodiment 29: The method of Embodiment 28, wherein the biomass is measured as dry-weight biomass.

Embodiment 30: The method of any one of Embodiments 1-29, wherein the yield of the plant is increased as compared to an uncontacted plant.

Embodiment 31: The method of Embodiment 30, wherein the yield is measured as grain harvest yield.

Embodiment 32: The method of any one of Embodiments 1-31, wherein the plant exhibits altered levels of non-photochemical quenching (NPQ) as compared to an uncontacted plant.

Embodiment 33: The method of any one of Embodiments 1-32, wherein the plant exhibits higher levels of carbon fixation as compared to an uncontacted plant.

Embodiment 34: The method of any one of Embodiments 1-33, wherein the plant exhibits higher levels of carbon storage as compared to an uncontacted plant.

Embodiment 35: The method of any one of Embodiments 1-34, wherein the plant exhibits a higher level of quantum efficiency (Fᵥ/Fₘ) as compared to an uncontacted plant.

Embodiment 36: The method of any one of Embodiments 1-35, wherein the plant exhibits a higher level of stomatal conductance as compared to an uncontacted plant.

Embodiment 37: The method of any one of Embodiments 1-36, wherein the plant exhibits a lower de-epoxidation level (A+Z/V+A+Z) as compared to an uncontacted plant.

Embodiment 38: The method of Embodiment 1 or Embodiment 2, wherein the compound is a compound according to Formula VI:

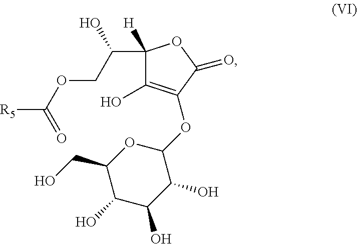

or a salt or solvate thereof.

Embodiment 39: The method of Embodiment 1 or Embodiment 2, wherein the compound is a compound according to a Formula is selected from:

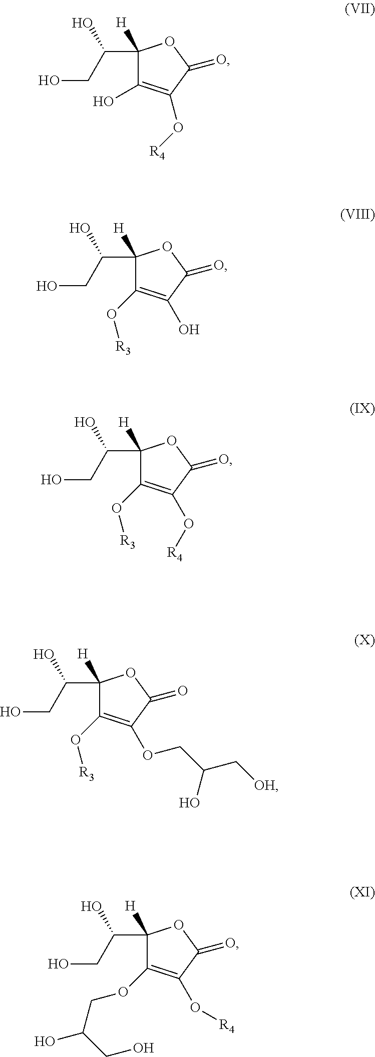

or a salt or solvate thereof.

Embodiment 40: The method of Embodiment 1 or Embodiment 2, wherein the compound is a compound according to a Formula is selected from:

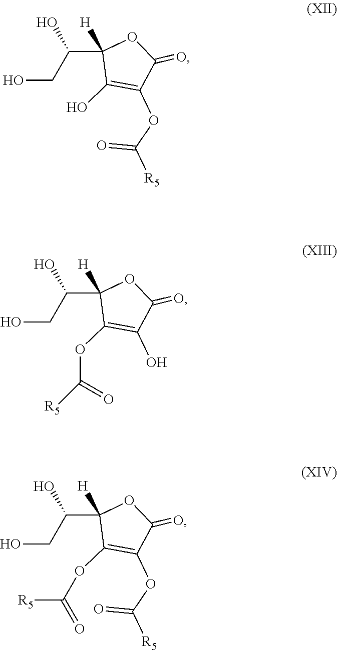

or a salt or solvate thereof.

Embodiment 41: The method of any one of Embodiments 19-24 and Embodiments 38-40, wherein the agricultural formulation further comprises a compound of formula:

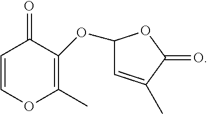 [SMILES: CC1=CC(Oc2c(C)occc2=O)OC1=O]

Embodiment 42: The method of any one of Embodiments 19-24 and Embodiments 38-40, wherein the agricultural formulation further comprises a compound of formula:

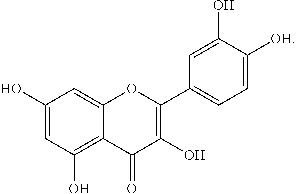 [SMILES: O=c1c(O)c(-c2ccc(O)c(O)c2)oc2cc(O)cc(O)c12]

Embodiment 43: The method of any one of Embodiments 1-27 and Embodiments 38-40, wherein the effective amount of a compound to be used for cultivating a plant is greater than or equal to 1 g/acre.

Embodiment 44: The method of Embodiment 43, wherein the effective amount of a compound to be used for cultivating a plant does not exceed 4000 g/acre.

Embodiment 45: The method of any one of Embodiments 1-27 and Embodiments 38-40, wherein the effective amount of a compound to be used for cultivating a plant is at least 4 g/acre and at most 20 g/acre.

Embodiment 46: The method of any one of Embodiments 1-27 and Embodiments 38-40, wherein the effective amount of a compound to be used for cultivating a plant is at least 40 g/acre and at most 200 g/acre.

Embodiment 47: The method of any one of Embodiments 1-27 and Embodiments 38-40, wherein the effective amount of a compound to be used for cultivating a plant is at least 400 g/acre and at most 2000 g/acre.

Embodiment 48: The method of Embodiment 19, wherein the agricultural formulation further comprises an N,N-dimethyl lactamide.

Embodiment 49: The method of Embodiment 19 and Embodiment 48, wherein the agricultural formulation concentration does not exceed 250 g/L of the compound according to Formula I.

Embodiment 50: The method of Embodiment 19 and Embodiment 48, wherein the agricultural formulation concentration does not exceed 300 g/L of the compound according to Formula I.

Embodiment 51: The method of Embodiment 19, wherein the carrier comprises sunflower oil.

Embodiment 52: The method of Embodiment 19 or 51, wherein the agricultural formulation further comprises a non-phototoxic emulsifier, a nonionic polymeric surfactant with high oil affinity, an inert powdered gelling grade of attapulgite clay and BHT.

Embodiment 53: The method according to any one of Embodiments 19, 51, and 52, wherein the agricultural formulation concentration does not exceed 250 g/L of the compound according to Formula I, a non-phototoxic emulsifier, a nonionic polymeric surfactant with high oil affinity, an inert powdered gelling grade of attapulgite clay and BHT.

Embodiment 54: The method according to any one of Embodiments 19 and 51-53, wherein the agricultural formulation concentration does not exceed 300 g/L of the compound according to Formula I, a non-phototoxic emulsifier, a nonionic polymeric surfactant with high oil affinity, an inert powdered gelling grade of attapulgite clay and BHT.

Embodiment 55: The method according to any one of Embodiments 52-54, wherein the non-phototoxic emulsifier is polyoxyethylene (40) sorbitol.

Embodiment 56: The method according to any one of Embodiments 52-54, wherein the nonionic polymeric surfactant with high oil affinity is CAS No. 173717-47-0.

Embodiment 57: The method according to any one of Embodiments 52-54, wherein the inert powdered gelling grade of attapulgite clay is CAS No. 12174-11-7.

Embodiment 58: A compound according to Formula I

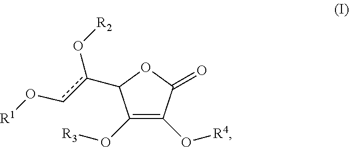

or a salt or solvate thereof, wherein:
[symbol] is either a single or double bond;
R¹, R², R³, and R⁴ are independently selected from the group consisting of H, C₁₋₆ alkyl, 2- to 6-membered heteroalkyl, C₃₋₈ cycloalkyl, C₆₋₁₀ aryl, (C₆₋₁₀ aryl)-C₆₋₁₀ alkyl, 5- to 12-membered heteroaryl, (5- to 12-membered heteroaryl)-C₆₋₁₀ alkyl, 5- to 12-membered heterocyclyl, —C(O)R⁵, —C(O)₂R⁵, —C(O)N(R⁵)₂, —S(O)R⁵, and —S(O)₂R⁵;
R¹ and R² are optionally taken together with the oxygen atoms to which they are attached to form a ring which is optionally substituted with one or more R⁶ groups or R⁷ groups;
each R⁵ is independently selected from the group consisting of H, C₁₋₆ alkyl, 2- to 6-membered heteroalkyl, C₃₋₈ cycloalkyl, C₆₋₁₀ aryl, (C₆₋₁₀ aryl)-C₆₋₁₀ alkyl, 5- to 12-membered heteroaryl, (5- to 12-membered heteroaryl)-C₆₋₁₀ alkyl, and 5- to 12-membered heterocyclyl;
each R⁶ and R⁷ is independently selected from the group consisting of H, halo, amino, hydroxy, —OR⁵, —N(R⁵)₂, C₁₋₆ alkyl, 2- to 6-membered heteroalkyl, C₃₋₈ cycloalkyl, C₆₋₁₀ aryl, (C₆₋₁₀ aryl)-C₆₋₁₀ alkyl, 5- to 12-membered heteroaryl, (5- to 12-membered heteroaryl)-C₆₋₁₀ alkyl, and 5- to 12-membered heterocyclyl.

Embodiment 59: A formulation comprising a compound according to Formula I, II, III, IV, V, VI, VII, VIII, IX, X, XI, XII, XIII, or XIV, or a salt or solvate thereof, and an agriculturally acceptable carrier.

Embodiment 60: The formulation of Embodiment 59, wherein the compound is a compound of Formula I.

Embodiment 61: The formulation of Embodiment 59, wherein the compound is a compound of Formula II.

Embodiment 62: The formulation of Embodiment 59, wherein the compound is a compound of Formula III.

Embodiment 63: The formulation of Embodiment 59, wherein the compound is a compound of Formula IV.

Embodiment 64: The formulation of Embodiment 59, wherein the compound is a compound of Formula V.

Embodiment 65: The formulation according to any one of Embodiments 59-64, wherein the compound is Compound I.

Embodiment 66: The formulation according to any one of Embodiments 59-65, wherein the formulation comprises one or more agriculturally acceptable carriers.

Embodiment 67: The formulation according to any one of Embodiments 59-66, wherein the one or more agriculturally acceptable carriers are present at a concentration ranging from about 50% w/w to about 99% w/w.

Embodiment 68: The formulation according to Embodiment 66, wherein the one or more agriculturally acceptable carriers are Agnique® AMD 3L (N,N-dimethyl lactamide) and/or sunflower oil.

Embodiment 69: The formulation according to any one of Embodiments 59-68, further comprising a surfactant.

Embodiment 70: The formulation according to Embodiment 69, wherein the surfactant is present at a concentration from about 0.1% to about 10% w/w.

Embodiment 71: The formulation according to any one of Embodiments 59-70, wherein the compound according to Formula I, II, III, IV, V, VI, VII, VIII, IX, X, XI, XII, XIII, or XIV is present at a concentration ranging from about 0.1% to about 50% w/w.

Embodiment 72: The formulation according to Embodiment 71, wherein the compound according to Formula I, II, III, IV, V, VI, VII, VIII, IX, X, XI, XII, XIII, or XIV is present at a concentration ranging from about 10% to about 30% w/w.

Embodiment 73: The formulation according to any one of Embodiments 59-72, wherein the compound according to Formula I, II, III, IV, V, VI, VII, VIII, IX, X, XI, XII, XIII, or XIV is present at a concentration effective to increase the carbon fixation of a plant at least about 5% relative to an uncontacted plant.

Embodiment 74: The formulation according to any one of Embodiments 59-73, wherein the compound according to Formula I, II, III, IV, V, VI, VII, VIII, IX, X, XI, XII, XIII, or XIV is present at a concentration effective to increase the carbon storage of a plant at least about 5% relative to an uncontacted plant.

Embodiment 75: The formulation according to any one of Embodiments 59-74, wherein the compound according to Formula I, II, III, IV, V, VI, VII, VIII, IX, X, XI, XII, XIII, or XIV is present at a concentration effective to increase the yield of a plant at least about 5% relative to an uncontacted plant.

Embodiment 76: The formulation according to any one of Embodiments 59-75, wherein the compound according to Formula I, II, III, IV, V, VI, VII, VIII, IX, X, XI, XII, XIII, or XIV is present at a concentration effective to increase the biomass of a plant at least about 5% relative to an uncontacted plant.

Embodiment 77: The formulation according to any one of Embodiments 59-76, wherein the compound according to Formula I, II, III, IV, V, VI, VII, VIII, IX, X, XI, XII, XIII, or XIV is present at a concentration effective to increase the quantum efficiency of a plant at least about 5% relative to an uncontacted plant.

Embodiment 78: The formulation according to any one of Embodiments 59-77, wherein the compound according to Formula I, II, III, IV, V, VI, VII, VIII, IX, X, XI, XII, XIII, or XIV is present at a concentration effective to increase the stomatal conductance of a plant at least about 5% relative to an uncontacted plant.

Embodiment 79: The formulation according to any one of Embodiments 59-78, wherein the compound according to Formula I, II, III, IV, V, VI, VII, VIII, IX, X, XI, XII, XIII, or XIV is present at a concentration effective to lower the de-epoxidation level of a plant at least about 5% relative to an uncontacted plant.

Although the foregoing has been described in some detail by way of illustration and example for purposes of clarity and understanding, one of skill in the art will appreciate that certain changes and modifications can be practiced within the scope of the appended claims. In addition, each reference provided herein is incorporated by reference in its entirety to the same extent as if each reference was individually incorporated by reference.

What is claimed is:

1. A method for cultivating a plant, the method comprising contacting the plant with an effective amount of a compound according to Formula I: 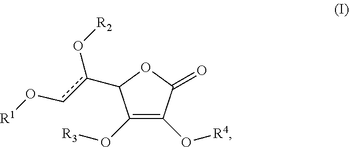
or a salt or solvate thereof, wherein: [symbol]
is either a single or double bond;
R¹ and R² are independently selected from the group consisting of H, C₁₋₆ alkyl, C₁₋₆ alkyl-diol, 2- to 6-membered heteroalkyl, C₃₋₈ cycloalkyl, C₆₋₁₀ aryl, (C₆₋₁₀ aryl)-C₆₋₁₀ alkyl, 5- to 12-membered heteroaryl, (5- to 12-membered heteroaryl)-C₆₋₁₀ alkyl, 5- to 12-membered heterocyclyl, —C(O)R⁵, —C(O)₂R⁵, —C(O)N(R⁵)₂, —S(O)R⁵, and —S(O)₂R⁵;
R¹ and R² are optionally taken together with the oxygen atoms to which they are attached to form a ring which is optionally substituted with one or more R⁶ groups or R⁷ groups;
R³ and R⁴ are independently selected from the group consisting of phosphate, hydrogen phosphate, monohydrogen phosphate, and dihydrogen phosphate, H, C₁₋₆ alkyl, C₁₋₆ alkyl-diol, 2- to 6-membered heteroalkyl, C₃-8 cycloalkyl, C₆₋₁₀ aryl, (C₆₋₁₀ aryl)-C₆₋₁₀ alkyl, 5- to 12-membered heteroaryl, (5- to 12-membered heteroaryl)-C₆₋₁₀ alkyl, 5- to 12-membered heterocyclyl, —C(O)R⁵, —C(O)₂R⁵, —C(O)N(R⁵)₂, —S(O)R⁵, and —S(O)₂R⁵;
each R⁵ is independently selected from the group consisting of H, C₁₋₆ alkyl, 2- to 6-membered heteroalkyl, C₃₋₈ cycloalkyl, C₆₋₁₀ aryl, hydroxy-(C₆₋₁₀ aryl), (C₆₋₁₀ aryl)-C₆₋₁₀ alkyl, 5- to 12-membered heteroaryl, (5- to 12-membered heteroaryl)-C₆₋₁₀ alkyl, 5- to 12-membered heterocyclyl, and 5- to 12-membered substituted heterocyclyl; and
each R⁶ and R⁷ is independently selected from the group consisting of H, halo, amino, hydroxy, —OR⁵, —N(R⁵)₂, C₁₋₆ alkyl, 2- to 6-membered heteroalkyl, C₃₋₈ cycloalkyl, C₆₋₁₀ aryl, (C₆₋₁₀ aryl)-C₆₋₁₀ alkyl, 5- to 12-membered heteroaryl, (5- to 12-membered heteroaryl)-C₆₋₁₀ alkyl, and 5- to 12-membered heterocyclyl.

2. The method of claim 1, wherein R¹ and R² are taken together with the oxygen atoms to which they are attached to form the ring which is optionally substituted with one or more R⁶ groups or R⁷ groups.

3. The method of claim 1 or claim 2, wherein the compound is a compound according to Formula II: 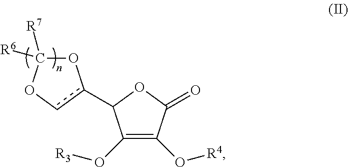
or a salt or solvate thereof,
wherein subscript n is 1, 2, 3, or 4.

4. The method of any one of claims 1-3, or a salt or solvate thereof, wherein [symbol] is a double bond.

5. The method of any one of claims 1-3, or a salt or solvate thereof, wherein [symbol] is a single bond.

6. The method of claim 5, wherein the compound is a compound according to Formula III: 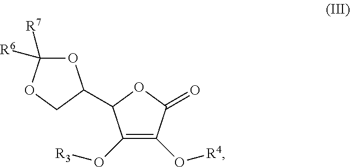
or a salt or solvate thereof.

7. The method or claim 6, wherein the compound is a compound according to Formula IV: 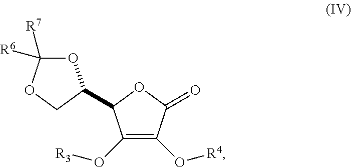
or a salt or solvate thereof.

8. The method of any one of claims 1-7, wherein R³, R⁴, each R⁶, and each R⁷ are independently selected from the group consisting of H and C₁₋₆ alkyl.

9. The method of claim 8, wherein R³, R⁴, each R⁶, and each R⁷ are independently C₁₋₆ alkyl.

10. The method of claim 9, wherein each of R³, R⁴, each R⁶, and each R⁷ are independently selected from the group consisting of methyl, ethyl, n-propyl, iso-propyl, n-butyl, sec-butyl, iso-butyl, and tert-butyl.

11. The method of claim 9, wherein each of R³, R⁴, each R⁶, and each R⁷ are methyl.

12. The method of any one of claims 1-7, wherein the compound is a compound according to Formula V: 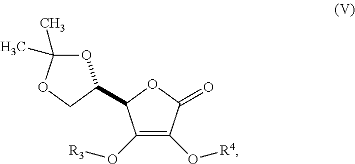
or a salt or solvate thereof,
wherein R³ and R⁴ are independently C₁₋₆ alkyl.

13. The method of claim 1, wherein R¹, R², R³, and R⁴ are independently selected from the group consisting of H and C₁₋₆ alkyl.

14. The method of claim 1 or claim 13, wherein R¹, R², R³, and R⁴ are independently C₁₋₆ alkyl.

15. The method of claim 14, wherein each of R¹, R², R³, and R⁴ are independently selected from the group consisting of methyl, ethyl, n-propyl, iso-propyl, n-butyl, sec-butyl, iso-butyl, and tert-butyl.

16. The method of claim 15, or a salt or solvate thereof, wherein each of R¹, R², R³, and R⁴ are methyl.

17. The method of any one of claims 1-16, wherein the plant is selected from the group consisting of cotton, alfalfa, Arabidopsis, banana, barley, canola, castor bean, chrysanthemum, clover, cocoa, coffee, cottonseed, corn (maize), crambe, cranberry, cucumber, dendrobium, dioscorea, eucalyptus, fescue, flax, gladiolus, liliacea, linseed, millet, muskmelon, mustard, oat, oil palm, oilseed rape, papaya, peanut, pineapple, ornamental plants, Phaseolus, potato, rapeseed, rice, rye, ryegrass, safflower, sesame, sorghum, soybean, sugarbeet, sugarcane, sunflower, strawberry, tobacco, tomato, turfgrass, wheat and vegetable crops such as lettuce, celery, broccoli, cauliflower, cucurbits, onions (including garlic, shallots, leeks, and chives); fruit and nut trees, such as apple, pear, peach, orange, grapefruit, lemon, lime, almond, pecan, walnut, hazel; vines, such as grapes, kiwi, hops; fruit shrubs and brambles, such as raspberry, blackberry, gooseberry; forest trees, such as ash, pine, fir, maple, oak, chestnut, poplar; with alfalfa, canola, castor bean, corn, cotton, crambe, flax, linseed, mustard, oil palm, oilseed rape, peanut, potato, rice, safflower, sesame, soybean, sugarbeet, sugarcane, sunflower, tomato and wheat.

18. The method of claim 17, wherein the plant is corn or soybean.

19. The method of any one of claims 1-18, wherein contacting the plant with the compound according to Formula I comprises contacting the plant with an agricultural formulation comprising the compound of Formula I, or a salt or solvate thereof, and an agriculturally acceptable carrier.

20. The method of claim 19, wherein the carrier comprises water.

21. The method of claim 19 or claim 20, wherein the agricultural formulation further comprises a surfactant, a dispersing agent, a wetting agent, a thickener, a stabilizer, a chelator, or combinations thereof.

22. The method of any one of claims 19-21, wherein the agricultural formulation further comprises a pesticide.

23. The method of any one of claims 19-22, wherein the agricultural formulation further comprises a bacterium, a virus, a fungus, or a combination thereof.

24. The method of any one of claims 19-23, wherein the agricultural formulation further comprises a plant growth regulator, an insect growth regulator, a microbial growth regulator, or a combination thereof.

25. The method of any one of claims 1-24 wherein the contacting comprises contacting a leaf of the plant, a stem of the plant, a root of the plant, or combinations thereof.

26. The method of any one of claims 1-25, wherein the formulation is applied as a foliar spray.

27. The method of claim 26, wherein the formulation is applied as an aqueous solution.

28. The method of any one of claims 1-27, wherein the contacting is sufficient to increase the biomass of the plant, relative to the biomass of a comparable plant grown for a comparable amount of time and not contacted with the compound.

29. The method of claim 28, wherein the biomass is measured as dry-weight biomass.

30. The method of any one of claims 1-29, wherein the yield of the plant is increased as compared to an uncontacted plant.

31. The method of claim 30, wherein the yield is measured as grain harvest yield.

32. The method of any one of claims 1-31, wherein the plant exhibits altered levels of non-photochemical quenching (NPQ) as compared to an uncontacted plant.

33. The method of any one of claims 1-32, wherein the plant exhibits higher levels of carbon fixation as compared to an uncontacted plant.

34. The method of any one of claims 1-33, wherein the plant exhibits higher levels of carbon storage as compared to an uncontacted plant.

35. The method of any one of claims 1-34, wherein the plant exhibits a higher level of quantum efficiency (Fᵥ/Fₘ) as compared to an uncontacted plant.

36. The method of any one of claims 1-35, wherein the plant exhibits a higher level of stomatal conductance as compared to an uncontacted plant.

37. The method of any one of claims 1-36, wherein the plant exhibits a lower de-epoxidation level (A+Z/V+A+Z) as compared to an uncontacted plant.

38. The method of claim 1 or claim 2, wherein the compound is a compound according to Formula VI: 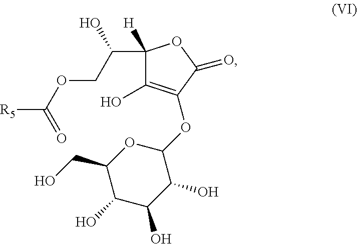
or a salt or solvate thereof.

39. The method of claim 1 or claim 2, wherein the compound is a compound according to a Formula is selected from: 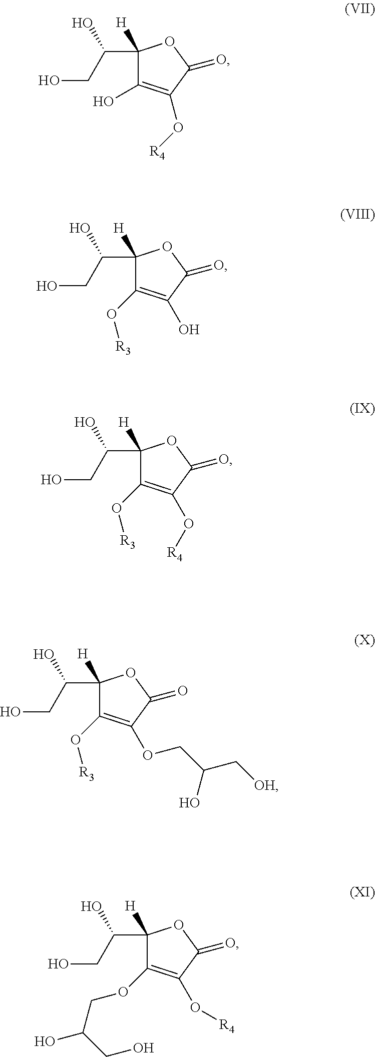
or a salt or solvate thereof.

40. The method of claim 1 or claim 2, wherein the compound is a compound according to a Formula is selected from: 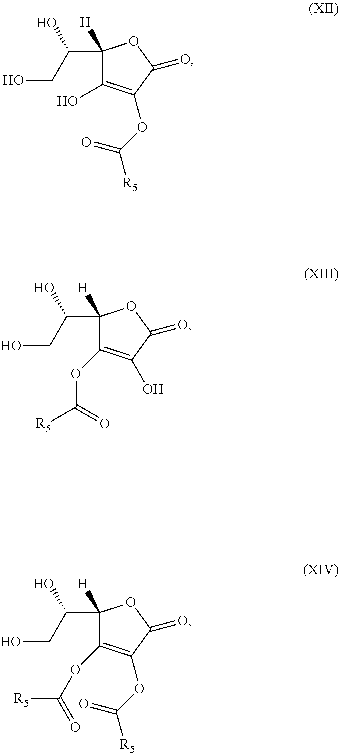
or a salt or solvate thereof.

41. The method of any one of claims 19-24 and claims 38-40, wherein the agricultural formulation further comprises a compound of formula:

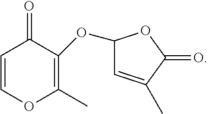 [SMILES: CC1=CC(Oc2c(C)occc2=O)OC1=O]

42. The method of any one of claims 19-24 and claims 38-40, wherein the agricultural formulation further comprises a compound of formula:

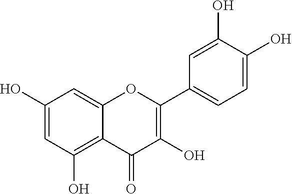 [SMILES: O=c1c(O)c(-c2ccc(O)c(O)c2)oc2cc(O)cc(O)c12]

43. The method of any one of claims 1-27 and claims 38-40, wherein the effective amount of a compound to be used for cultivating a plant is greater than or equal to 1 g/acre.

44. The method of claim 43, wherein the effective amount of a compound to be used for cultivating a plant does not exceed 4000 g/acre.

45. The method of any one of claims 1-27 and claims 38-40, wherein the effective amount of a compound to be used for cultivating a plant is at least 4 g/acre and at most 20 g/acre.

46. The method of any one of claims 1-27 and claims 38-40, wherein the effective amount of a compound to be used for cultivating a plant is at least 40 g/acre and at most 200 g/acre.

47. The method of any one of claims 1-27 and claims 38-40, wherein the effective amount of a compound to be used for cultivating a plant is at least 400 g/acre and at most 2000 g/acre.

48. The method of claim 19, wherein the agricultural formulation further comprises an N,N-dimethyl lactamide.

49. The method of claim 19 and claim 48, wherein the agricultural formulation concentration does not exceed 250 g/L of the compound according to Formula I.

50. The method of claim 19 and claim 48, wherein the agricultural formulation concentration does not exceed 300 g/L of the compound according to Formula I.

51. The method of claim 19, wherein the carrier comprises sunflower oil.

52. The method of claim 19 or 51, wherein the agricultural formulation further comprises a non-phototoxic emulsifier, a nonionic polymeric surfactant with high oil affinity, an inert powdered gelling grade of attapulgite clay and BHT.

53. The method according to any one of claims 19, 51, and 52, wherein the agricultural formulation concentration does not exceed 250 g/L of the compound according to Formula I, a non-phototoxic emulsifier, a nonionic polymeric surfactant with high oil affinity, an inert powdered gelling grade of attapulgite clay and BHT.

54. The method according to any one of claims 19 and 51-53, wherein the agricultural formulation concentration does not exceed 300 g/L of the compound according to Formula I, a non-phototoxic emulsifier, a nonionic polymeric surfactant with high oil affinity, an inert powdered gelling grade of attapulgite clay and BHT.

55. The method according to any one of claims 52-54, wherein the non-phototoxic emulsifier is polyoxyethylene (40) sorbitol.

56. The method according to any one of claims 52-54, wherein the nonionic polymeric surfactant with high oil affinity is CAS No. 173717-47-0.

57. The method according to any one of claims 52-54, wherein the inert powdered gelling grade of attapulgite clay is CAS No. 12174-11-7.

58. A formulation comprising a compound according to Formula I, II, III, IV, V, VI, VII, VIII, IX, X, XI, XII, XIII, or XIV, or a salt or solvate thereof, and an agriculturally acceptable carrier.

59. The formulation of claim 58, wherein the compound is a compound of Formula I.

60. The formulation of claim 58, wherein the compound is a compound of Formula II.

61. The formulation of claim 58, wherein the compound is a compound of Formula III.

62. The formulation of claim 58, wherein the compound is a compound of Formula IV.

63. The formulation of claim 58, wherein the compound is a compound of Formula V.

64. The formulation according to any one of claims 58-63, wherein the compound is Compound I.

65. The formulation according to any one of claims 58-64, wherein the formulation comprises one or more agriculturally acceptable carriers.

66. The formulation according to any one of claims 58-65, wherein the one or more agriculturally acceptable carriers are present at a concentration ranging from about 50% w/w to about 99% w/w.

67. The formulation according to claim 65, wherein the one or more agriculturally acceptable carriers are Agnique® AMD 3L (N,N-dimethyl lactamide) and/or sunflower oil.

68. The formulation according to any one of claims 58-67, further comprising a surfactant.

69. The formulation according to claim 68, wherein the surfactant is present at a concentration from about 0.1% to about 10% w/w.

70. The formulation according to any one of claims 58-69, wherein the compound according to Formula I, II, III, IV, V, VI, VII, VIII, IX, X, XI, XII, XIII, or XIV is present at a concentration ranging from about 0.1% to about 50% w/w.

71. The formulation according to claim 70, wherein the compound according to Formula I, II, III, IV, V, VI, VII, VIII, IX, X, XI, XII, XIII, or XIV is present at a concentration ranging from about 10% to about 30% w/w.

72. The formulation according to any one of claims 58-71, wherein the compound according to Formula I, II, III, IV, V, VI, VII, VIII, IX, X, XI, XII, XIII, or XIV is present at a concentration effective to increase the carbon fixation of a plant at least about 5% relative to an uncontacted plant.

73. The formulation according to any one of claims 58-72, wherein the compound according to Formula I, II, III, IV, V, VI, VII, VIII, IX, X, XI, XII, XIII, or XIV is present at a concentration effective to increase the carbon storage of a plant at least about 5% relative to an uncontacted plant.

74. The formulation according to any one of claims 58-73, wherein the compound according to Formula I, II, III, IV, V, VI, VII, VIII, IX, X, XI, XII, XIII, or XIV is present at a concentration effective to increase the yield of a plant at least about 5% relative to an uncontacted plant.

75. The formulation according to any one of claims 58-74, wherein the compound according to Formula I, II, III, IV, V, VI, VII, VIII, IX, X, XI, XII, XIII, or XIV is present at a concentration effective to increase the biomass of a plant at least about 5% relative to an uncontacted plant.

76. The formulation according to any one of claims 58-75, wherein the compound according to Formula I, II, III, IV, V, VI, VII, VIII, IX, X, XI, XII, XIII, or XIV is present at a concentration effective to increase the quantum efficiency of a plant at least about 5% relative to an uncontacted plant.

77. The formulation according to any one of claims 58-76, wherein the compound according to Formula I, II, III, IV, V, VI, VII, VIII, IX, X, XI, XII, XIII, or XIV is present at a concentration effective to increase the stomatal conductance of a plant at least about 5% relative to an uncontacted plant.

78. The formulation according to any one of claims 58-77, wherein the compound according to Formula I, II, III, IV, V, VI, VII, VIII, IX, X, XI, XII, XIII, or XIV is present at a concentration effective to lower the de-epoxidation level of a plant at least about 5% relative to an uncontacted plant.
